(19) United States
(12) Patent Application Publication
(10) Pub. No.: US 2026/0032276 A1
(43) Pub. Date: Jan. 29, 2026

(54) IMAGE PROCESSING METHOD, PROCESSING DEVICE AND STORAGE MEDIUM

(71) Applicant: SHENZHEN TRANSSION HOLDINGS CO., LTD., Shenzhen (CN)

(72) Inventor: Yutian LIU, Shenzhen (CN)

(73) Assignee: SHENZHEN TRANSSION HOLDINGS CO., LTD., Shenzhen (CN)

(21) Appl. No.: 19/346,847

(22) Filed: Oct. 1, 2025

Related U.S. Application Data
(63) Continuation of application No. PCT/CN2024/072534, filed on Jan. 16, 2024.

(30) Foreign Application Priority Data
Apr. 10, 2023 (CN) 202310370419.5

(51) Int. Cl. H04N 19/50; H04N 19/137

(52) U.S. Cl. CPC H04N 19/50; H04N 19/137

(57) ABSTRACT

An image processing method can be applied to the processing device, including: determining or obtaining a prediction result for the unit to be processed based on the motion information of a sub-processing unit within the unit to be processed. During the image encoding and decoding process, the technical solution of the present application can make the trajectory represented by the motion offset parameters determined for the unit to be processed similar to the actual motion trajectory of the unit to be processed, thereby improving the prediction accuracy and/or efficiency of video encoding.

### CROSS-REFERENCE TO RELATED APPLICATIONS

This application is a continuation application of International Application No. PCT/CN2024/072534, filed on Jan. 16, 2024, which claims priority to Chinese Patent Application No. 202310370419.5, filed on Apr. 10, 2023. The disclosures of the above-mentioned application are incorporated herein by reference in their entireties.

### TECHNICAL FIELD

The present application relates to the technical field of image processing, and in particular to an image processing method, a processing device and a storage medium.

### BACKGROUND

In the development of video coding technology, improvements made to various video coding standards have been aimed at improving video coding performance in various aspects. The predictive processing in image coding and decoding based on sub-block motion offsets is a hot topic in current research.

During the process of conceiving and implementing the present application, the inventors discovered at least the following problem: there is a significant error between the trajectory represented by the motion offset determined in the related art and the actual motion trajectory of the unit being processed, resulting in low prediction accuracy and/or low efficiency in video coding.

The preceding description is intended to provide general background information and does not necessarily constitute prior art.

### SUMMARY

In response to the above technical problems, the present application provides an image processing method, a processing device and a storage medium, so that the trajectory represented by the determined motion offset parameters and the actual motion trajectory of the unit to be processed remain consistent or similar, thereby effectively improving the prediction accuracy and/or efficiency of video encoding.

In order to solve the above technical problem, the present application provides an image processing method, which can be applied to a processing device, including:
obtaining or determining motion information of a sub-processing unit within a unit to be processed; and
performing luminance and chrominance prediction on the unit to be processed based on the motion information to determine or obtain a prediction result for the unit to be processed.

In an embodiment, methods for obtaining or determining the motion information of the sub-processing unit include at least one of the following:
a first method: obtaining or determining the motion information based on a collocated processing unit of the unit to be processed;
a second method: obtaining or determining the motion information based on a collocated sub-processing unit of the sub-processing unit;
a third method: obtaining or determining the motion information based on a preset sub-block merge candidate list;
a fourth method: obtaining or determining the motion information based on a preset flag;
a fifth method: obtaining or determining the motion information based on first motion offset information;
a sixth method: obtaining or determining the motion information based on second motion offset information of a first image unit or a first sub-image unit in a processed area of an image to be processed;
a seventh method: obtaining or determining the motion information based on a combination of at least one of the second motion offset information; and
an eighth method: obtaining or determining the motion information based on a motion vector prediction candidate list.

In an embodiment, the second method includes:
determining a collocated sub-processing unit based on the third motion offset information, the position information of the sub-processing unit, and the motion offset information; and
obtaining or determining the motion information of the sub-processing unit based on the position information of the collocated sub-processing unit and/or the motion information of the center sample of the collocated sub-processing unit.

In an embodiment, the fourth method includes:
in response to the preset flag being a first value, obtaining or determining the motion information of the sub-processing unit based on the motion information of the collocated sub-processing unit; and/or
in response to the preset flag being a second value, obtaining or determining the motion information of the sub-processing unit based on the motion information of a center sample of the collocated processing unit of the unit to be processed.

In an embodiment, the fifth method includes:
obtaining or determining first motion offset information based on at least one corresponding first motion information of at least one adjacent area, at least one neighboring area, at least one adjacent sample, or at least one neighboring sample, or obtaining or determining first motion offset information based on a motion offset information list; and
obtaining or determining the motion information of the sub-processing unit based on the first motion offset information.

In an embodiment, the step of obtaining or determining the motion information of the sub-processing unit based on the first motion offset information includes:
determining the collocated sub-processing unit based on the position information of the sub-processing unit and the first motion offset information; and
obtaining or determining the motion information of the sub-processing unit based on the position information and/or the motion information of the collocated sub-processing unit.

In an embodiment, the sixth method includes:
determining the first motion offset information based on second motion offset information, and obtaining or determining the motion information of the sub-processing unit based on the first motion offset information.

In an embodiment, the method further includes at least one of the following:
the first image unit is an image unit of the same size as the unit to be processed;
the first sub-image unit is a sub-image unit of the same size as the sub-processing unit;
the second motion offset information includes: motion information of at least one first area and/or at least one first sample of the first image unit or the first sub-image unit; and
the preset flag includes a first value and/or a second value.

The present application further provides a processing device, including a memory and a processor, an image processing program is stored in the memory, and when the image processing program is executed by the processor, the steps of any of the above-mentioned image processing methods are implemented.

The present application further provides a storage medium storing a computer program, and the computer program, when executed by a processor, implements the steps of any of the above-mentioned image processing methods.

As described above, the image processing method of the present application can be applied to a processing device and includes determining or obtaining a prediction result for the unit to be processed based on motion information of a sub-processing unit within the unit to be processed. Through the above technical solution, the trajectory represented by the motion offset parameters determined for the unit to be processed during the image encoding and decoding process can be ensured to be consistent or similar to the actual motion trajectory of the unit to be processed, thereby effectively improving the prediction accuracy and/or efficiency of video encoding.

### BRIEF DESCRIPTION OF THE DRAWINGS

The accompanying drawings, which are incorporated in and constitute a part of this specification, illustrate embodiments consistent with the present application and together with the description, serve to explain the principles of the present application. In order to explain the technical solutions of the embodiments of the present application more clearly, the drawings needed to be used in the description of the embodiments will be briefly introduced below. Obviously, for those of ordinary skill in the art, other drawings can be obtained based on these drawings without exerting creative efforts.

FIG. 1 is a schematic diagram of the hardware structure of a mobile terminal that implements various embodiments of the present application.

FIG. 2 is a communication network system architecture diagram according to an embodiment of the present application.

FIG. 3A is a schematic diagram of spatially adjacent blocks used in ATMVP.

FIG. 3B is a schematic diagram of the process of sub-block-based temporal motion vector prediction (SbTMVP) in versatile video coding (VVC).

FIG. 4A is a schematic diagram of an image encoding scenario involved in the image processing method provided in an embodiment of the present application.

FIG. 4B is a schematic diagram of an image decoding scenario involved in the image processing method provided in an embodiment of the present application.

FIG. 5 is a schematic diagram of the relationship between the processing unit and the sub-processing units within the processing unit according to a first embodiment of the present application.

FIG. 6 is a schematic diagram of the relationship between the current picture and the collocated picture according to a second embodiment of the present application.

FIG. 7A is a schematic diagram of an adjacent area between the processing unit and the sub-processing unit according to the second embodiment of the present application.

FIG. 7B is a schematic diagram of another adjacent area between the processing unit and the sub-processing unit according to the second embodiment of the present application.

FIG. 8 is a schematic diagram of adjacent samples between the processing unit and the sub-processing unit according to the second embodiment of the present application.

FIG. 9 is a schematic diagram of adjacent areas of a processing unit and a sub-processing unit according to the second embodiment of the present application.

FIG. 10 is a schematic diagram of determining a collocated sub-processing unit based on a motion vector according to the second embodiment of the present application.

FIG. 11 is a schematic diagram of determining corresponding collocated picture blocks for multiple candidate offsets according to a fourth embodiment of the present application.

FIG. 12A to FIG. 12D are schematic diagrams of determining sub-image block motion vectors using collocated picture blocks according to the fourth embodiment of the present application.

FIG. 13 is a schematic diagram of determining collocated sub-image blocks for multiple candidate offsets according to the fourth embodiment of the present application.

FIG. 14A and FIG. 14B are schematic diagrams of determining sub-image block motion vectors using collocated sub-image blocks according to the fourth embodiment of the present application.

FIG. 15 is a schematic diagram of determining collocated picture blocks for multiple candidate offsets according to the fourth embodiment of the present application.

FIG. 16A to FIG. 16D are schematic diagrams of determining sub-image block motion vectors using collocated picture blocks according to the fourth embodiment of the present application.

FIG. 17 is a schematic diagram of directly determining a collocated sub-image block for multiple candidate offsets according to the fourth embodiment of the present application.

FIG. 18A and FIG. 18B are schematic diagrams of determining a sub-image block motion vector using a collocated sub-image block according to the fourth embodiment of the present application.

FIG. 19 is a schematic diagram of selecting a sub-image block according to the fourth embodiment of the present application.

FIG. 20 is a schematic diagram of selecting multiple sub-image blocks according to the fourth embodiment of the present application.

FIG. 21 is a schematic diagram of determining a collocated sub-image block for multiple candidate offsets according to the fourth embodiment of the present application.

FIG. 22A and FIG. 22B are schematic diagrams of determining a sub-image block motion vector using a collocated sub-image block according to the fourth embodiment of the present application.

The realization of the purpose, functional features and advantages of the present application will be further described in conjunction with the embodiments and with reference to the accompanying drawings. The above-mentioned drawings have shown clear embodiments of the present application, which will be described in more detail later. These drawings and textual descriptions are not intended to limit the scope of the concept of the present application in any way, but to illustrate the concept of the present application to those skilled in the art by referring to specific embodiments.

### DETAILED DESCRIPTION OF THE EMBODIMENTS

Exemplary embodiments will be described in detail herein, examples of which are illustrated in the accompanying drawings. When the following description refers to the drawings, unless otherwise indicated, the same numbers in different drawings refer to the same or similar elements. The implementations described in the following exemplary embodiments do not represent all implementations consistent with the present application. Rather, they are merely examples of apparatus and methods consistent with aspects of the present application as detailed in the appended claims.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element. In addition, components, features, and elements with the same name in different embodiments of the present application may have the same or different meanings. Its specific meaning needs to be determined according to its explanation in the specific embodiment or further combined with the context in the specific embodiment.

It should be understood that although the terms first, second, third, etc. may be used herein to describe various information, the information should not be limited to these terms. These terms are only used to distinguish information of the same type from one another. For example, without departing from the scope of this document, first information may also be called second information, and similarly, second information may also be called first information. Depending on the context, the word “if” as used herein may be interpreted as “at” or “when” or “in response to a determination”. Furthermore, as used herein, the singular forms “a”, “an” and “the” are intended to include the plural forms as well, unless the context indicates otherwise. It should be further understood that the terms “comprising”, “including” indicate the existence of features, steps, operations, elements, components, items, species, and/or groups, but does not exclude the existence, occurrence or addition of one or more other features, steps, operations, elements, components, items, species, and/or groups. The terms “or”, “and/or”, “comprising at least one of” and the like used in the present application may be interpreted as inclusive, or mean any one or any combination. For example, “comprising at least one of: A, B, C” means “any of: A; B; C; A and B; A and C; B and C; A and B and C”. As another example, “A, B, or C” or “A, B, and/or C” means “any of the following: A; B; C; A and B; A and C; B and C; A and B and C”. Exceptions to this definition will only arise when combinations of elements, functions, steps or operations are inherently mutually exclusive in some way.

It should be understood that although the various steps in the flowchart in the embodiment of the present application are displayed sequentially as indicated by the arrows, these steps are not necessarily executed sequentially in the order indicated by the arrows. Unless otherwise specified herein, there is no strict order restriction on the execution of these steps, and they can be executed in other orders. Moreover, at least some of the steps in the figure may include multiple sub-steps or multiple stages, these sub-steps or stages are not necessarily executed at the same time, but can be executed at different times. The execution sequence thereof is not necessarily performed sequentially, but may be performed alternately or in turn with at least one part of other steps or sub-steps or stages of other steps.

Depending on the context, the words “if” as used herein may be interpreted as “at” or “when” or “in response to determining” or “in response to detecting”. Similarly, depending on the context, the phrases “if determined” or “if detected (the stated condition or event)” could be interpreted as “when determined” or “in response to the determination” or “when detected (the stated condition or event)” or “in response to detection (the stated condition or event)”.

It should be understood that the specific embodiments described here are only used to explain the present application, and are not intended to limit the present application.

It should be understood that the specific embodiments described here are only used to explain the present application, and are not intended to limit the present application.

In the following description, the use of suffixes such as “module”, “part” or “unit” for denoting elements is only for facilitating the description of the present application and has no specific meaning by itself. Therefore, “module”, “part” or “unit” may be used in combination.

The communication device mentioned in the present application can be a terminal device (such as a mobile terminal, specifically a mobile phone) or a network device (such as a base station). The specific reference needs to be clarified in the context. The terminal device can be implemented in various forms. For example, the terminal device described in the present application can include a mobile phone, a tablet computer, a notepad computer, a hand-held computer, a personal digital assistants (PDA), a portable media player (PMP), a navigation device, a wearable device, a smart bracelet, a pedometer and other terminal devices, as well as a fixed terminal device such as a digital TV and a desktop computer.

The present application takes a mobile terminal as an example to illustrate. Those skilled in the art will understand that, in addition to elements specifically used for mobile purposes, the configuration according to the embodiments of the present application can also be applied to the fixed terminal device.

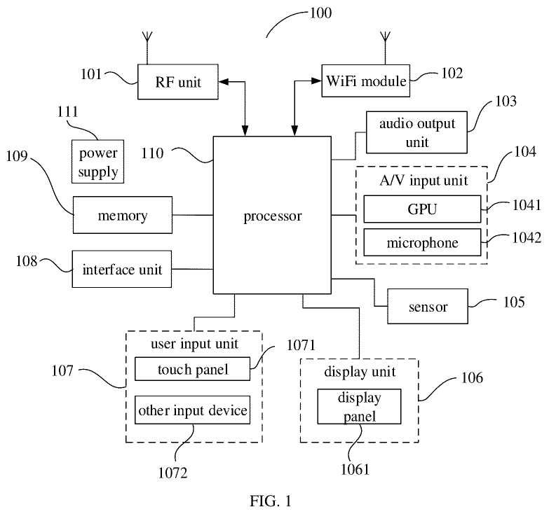

As shown in FIG. 1, it is a schematic structural diagram of the hardware of a mobile terminal that implements various embodiments of the present application. The mobile terminal 100 can include a Radio Frequency (RF) unit 101, a WiFi module 102, an audio output unit 103, an audio/video (A/V) input unit 104, a sensor 105, a display unit 106, a user input unit 107, an interface unit 108, a memory 109, a processor 110, a power supply 111 and other components. Those skilled in the art can understand that the structure of the mobile terminal shown in FIG. 1 does not constitute a limitation on the mobile terminal. The mobile terminal can include more or fewer components, or a combination of some components, or differently arranged components than shown in the figure.

Hereinafter, each component of the mobile terminal will be specifically introduced with reference to FIG. 1.

The radio frequency unit 101 can be used for transmitting and receiving signals during the process of transceiving information or talking. Specifically, after receiving the downlink information of the base station, the downlink information is processed by the processor 110; in addition, the uplink data is sent to the base station. Generally, the radio frequency unit 101 includes, but is not limited to, an antenna, at least one amplifier, a transceiver, a coupler, a low noise amplifier, a duplexer, and the like. In addition, the radio frequency unit 101 can also communicate with the network and other devices through wireless communication. The above-mentioned wireless communication can use any communication standard or protocol, including but not limited to Global System of Mobile communication (GSM), General Packet Radio Service (GPRS), Code Division Multiple Access 2000 (CDMA2000), Wideband Code Division Multiple Access (WCDMA), Time Division-Synchronous Code Division Multiple Access (TD-SCDMA), Frequency Division Duplexing-Long Term Evolution (FDD-LTE), Time Division Duplexing-Long Term Evolution (TDD-LTE), and 5G, or the like.

Wi-Fi is a short-range wireless transmission technology. The mobile terminal can help users transmit and receive email, browse webpage, and access streaming media through the Wi-Fi module 102, and Wi-Fi provides users with wireless broadband Internet access. Although FIG. 1 shows the Wi-Fi module 102, it is understandable that it is not a necessary component of the mobile terminal and can be omitted as needed without changing the essence of the present application.

When the mobile terminal 100 is in a call signal receiving mode, a call mode, a denoting mode, a voice recognition mode, a broadcast receiving mode, or the like, the audio output unit 103 can convert the audio data received by the radio frequency unit 101 or the Wi-Fi module 102 or stored in the memory 109 into an audio signal and output the audio signal as sound. Moreover, the audio output unit 103 can also provide audio output related to a specific function performed by the mobile terminal 100 (for example, call signal reception sound, message reception sound, or the like). The audio output unit 103 can include a speaker, a buzzer, or the like.

The A/V input unit 104 is configured to receive audio or video signals. The A/V input unit 104 can include a graphics processing unit (GPU) 1041 and a microphone 1042. The graphics processing unit 1041 processes image data of still pictures or videos obtained by an image capture device (such as a camera) in a video capture mode or an image capture mode. The processed image frame can be displayed on the display unit 106. The image frame processed by the graphics processing unit 1041 can be stored in the memory 109 (or other storage medium) or sent via the radio frequency unit 101 or the Wi-Fi module 102. The microphone 1042 can receive sound (audio data) in operation modes such as a call mode, a denoting mode, a voice recognition mode, and the like, and can process such sound into audio data. The processed audio (voice) data can be converted into a format that can be sent to a mobile communication base station via the radio frequency unit 101 in the case of a call mode for output. The microphone 1042 can implement various types of noise cancellation (or suppression) algorithms to eliminate (or suppress) noise or interference generated during the process of transceiving audio signals.

The mobile terminal 100 also includes at least one sensor 105, such as a light sensor, a motion sensor, and other sensors. Specifically, the light sensor includes an ambient light sensor and a proximity sensor. The ambient light sensor can adjust the brightness of the display panel 1061 according to the brightness of the ambient light. The proximity sensor can turn off the display panel 1061 and/or the backlight when the mobile terminal 100 is moved to the ear. A gravity acceleration sensor, as a kind of motion sensor, can detect the magnitude of acceleration in various directions (usually three axes). The gravity acceleration sensor can detect the magnitude and direction of gravity when it is stationary, and can identify the gesture of the mobile terminal (such as horizontal and vertical screen switch, related games, magnetometer attitude calibration), vibration recognition related functions (such as pedometer, tap), or the like. The mobile terminal can also be equipped with other sensors such as a fingerprint sensor, a pressure sensor, an iris sensor, a molecular sensor, a gyroscope, a barometer, a hygrometer, a thermometer, an infrared sensor and other sensors, which will not be repeated herein.

The display unit 106 is configured to display information input by the user or information provided to the user. The display unit 106 can include a display panel 1061, and the display panel 1061 can be configured in the form of a liquid crystal display (LCD), an organic light-emitting diode (OLED), or the like.

The user input unit 107 can be configured to receive numeric or character input, and generate key signal input related to user settings and function control of the mobile terminal. Specifically, the user input unit 107 can include a touch panel 1071 and other input devices 1072. The touch panel 1071, also called a touch screen, can collect user touch operations on or near it (for example, the user uses fingers, stylus and other suitable objects or accessories to operate on the touch panel 1071 or near the touch panel 1071), and drive the corresponding connection device according to a preset program. The touch panel 1071 can include two parts: a touch detection device and a touch controller. The touch detection device detects the user's touch position, detects the signal brought by the touch operation, and transmits the signal to the touch controller. The touch controller receives the touch information from the touch detection device, converts the touch information into contact coordinates, and transmits it to the processor 110, and can receive and execute the instructions sent by the processor 110. In addition, the touch panel 1071 can be implemented in multiple types such as resistive, capacitive, infrared, and surface acoustic wave. In addition to the touch panel 1071, the user input unit 107 can also include other input devices 1072. Specifically, the other input devices 1072 can include, but are not limited to, one or more of physical keyboard, function keys (such as volume control buttons, switch buttons, etc.), trackball, mouse, joystick, etc., which are not specifically limited here.

Further, the touch panel 1071 can cover the display panel 1061. After the touch panel 1071 detects a touch operation on or near it, the touch operation is transmitted to the processor 110 to determine the type of the touch event, and then the processor 110 provides a corresponding visual output on the display panel 1061 according to the type of the touch event. Although in FIG. 1, the touch panel 1071 and the display panel 1061 are used as two independent components to realize the input and output functions of the mobile terminal, in some embodiments, the touch panel 1071 and the display panel 1061 can be integrated to implement the input and output functions of the mobile terminal, which is not specifically limited here.

The interface unit 108 serves as an interface through which at least one external device can be connected to the mobile terminal 100. For example, the external device can include a wired or wireless earphone port, an external power source (or battery charger) port, a wired or wireless data port, a memory card port, a port for connecting devices with identification modules, an audio input/output (I/O) port, a video I/O port, an earphone port, or the like. The interface unit 108 can be configured to receive input (such as data information, electricity, or the like) from an external device and transmit the received input to one or more elements in the mobile terminal 100 or can be configured to transfer data between the mobile terminal 100 and the external device.

The memory 109 can be configured to store software programs and various data. The memory 109 can mainly include a program storage area and a data storage area. The program storage area can store the operating system, at least one application required for the function (such as sound play function, image play function, etc.), or the like. The data storage area can store data (such as audio data, phone book, etc.) created based on the use of the mobile phone. In addition, the memory 109 can include a high-speed random access memory, and can also include a non-volatile memory, such as at least one magnetic disk storage device, a flash memory device, or other non-volatile solid-state storage devices.

The processor 110 is a control center of the mobile terminal, and uses various interfaces and lines to connect the various parts of the entire mobile terminal. By running or performing the software programs and/or modules stored in the memory 109, and calling the data stored in the memory 109, various functions and processing data of the mobile terminal are executed, thereby overall monitoring of the mobile terminal is performed. The processor 110 can include one or more processing units; and the processor 110 may integrate an application processor and a modem processor. The application processor mainly processes an operating system, a user interface, an application, or the like, and the modem processor mainly processes wireless communication. It can be understood that the foregoing modem processor may not be integrated into the processor 110.

The mobile terminal 100 can also include a power source 111 (such as a battery) for supplying power to various components. The power supply 111 can be logically connected to the processor 110 through a power management system, so that functions such as charging, discharging, and power consumption management can be managed through the power management system.

Although not shown in FIG. 1, the mobile terminal 100 can also include a Bluetooth module, or the like, which will not be repeated herein.

In order to facilitate the understanding of the embodiments of the present application, the following describes the communication network system on which the mobile terminal of the present application is based.

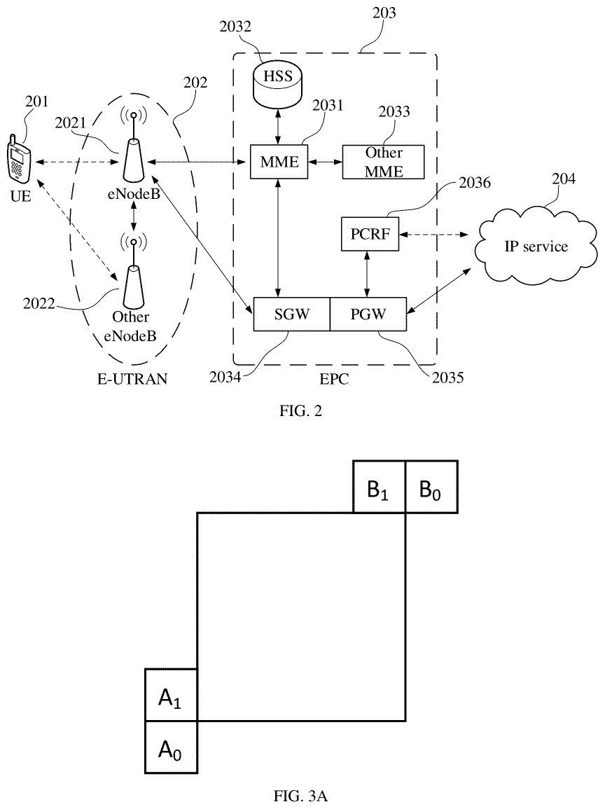

As shown in FIG. 2, it is a communication network system architecture diagram according to an embodiment of the present application. The communication network system is an LTE system of general mobile communication network technology. The LTE system includes a User Equipment (UE) 201, an Evolved UMTS Terrestrial Radio Access Network (E-UTRAN) 202, an Evolved Packet Core (EPC) 203, and an operator's IP service 204 that are sequentially connected in communication.

Optionally, the UE 201 can be the aforementioned terminal 100, which will not be repeated here.

E-UTRAN 202 includes eNodeB 2021 and other eNodeBs 2022. The eNodeB 2021 can be connected to other eNodeBs 2022 through a backhaul (for example, an X2 interface), the eNodeB 2021 is connected to the EPC 203, and the eNodeB 2021 can provide access from the UE 201 to the EPC 203.

The EPC 203 can include Mobility Management Entity (MME) 2031, Home Subscriber Server (HSS) 2032, other MMEs 2033, Serving Gate Way (SGW) 2034, PDN Gate Way (PGW) 2035, Policy and Charging Rules Function (PCRF) 2036, and so on. MME 2031 is a control node that processes signaling between UE 201 and EPC 203, and provides bearer and connection management. HSS 2032 is configured to provide some registers to manage functions such as the home location register (not shown), and save some user-specific information about service feature, data rates, and so on. All user data can be sent through SGW 2034, PGW 2035 can provide UE 201 IP address allocation and other functions. PCRF 2036 is a policy and charging control policy decision point for service data flows and IP bearer resources, which selects and provides available policy and charging control decisions for policy and charging execution functional units (not shown).

The IP service 204 can include Internet, intranet, IP Multimedia Subsystem (IMS), or other IP services.

Although the LTE system is described above as an example, those skilled in the art should know that, the present application is not only applicable to the LTE system, but also applicable to other wireless communication systems, such as GSM, CDMA2000, WCDMA, TD-SCDMA, 5G and new network systems in the future (such as 6G), or the like, which is not limited herein.

Based on the hardware structure of the processing device and the communication network system taking the mobile terminal as an example, the overall concept of the image processing method of the present application is proposed.

In the development of video coding technology, improvements made to various video coding standards have been aimed at improving video coding performance in various aspects. The predictive processing in image coding and decoding based on sub-block motion offsets is a hot topic in current research.

During the process of conceiving and implementing the present application, the inventors discovered at least the following problem: there is a significant error between the trajectory represented by the motion offset determined in the related art and the actual motion trajectory of the unit being processed, resulting in low prediction accuracy and/or low efficiency in video coding.

The preceding description is intended to provide general background information and does not necessarily constitute prior art.

To address the above-mentioned issues, the present application proposes an image processing method that determines or obtains a prediction result for a unit to be processed based on the motion information of a sub-processing unit within the unit to be processed. This technical solution ensures that the trajectory represented by the motion offset parameters determined for the unit to be processed during the image encoding and decoding process remains consistent or similar to the actual motion trajectory of the unit to be processed, thereby effectively improving the prediction accuracy and/or efficiency of video encoding.

Based on the overall concept of the image processing method provided above, various embodiments of the image processing method of the present application are further proposed.

To facilitate understanding, the following explains some of the technical terms that may be used in the embodiments of the present application.

### (I) Inter-Frame Prediction

Predicting image blocks is an essential step in the encoding or decoding process. For example, the encoder predicts an image block to generate a prediction block, thereby constructing a low-energy residual block to reduce transmission bits. The decoder decodes the image by entropy decoding the residual block and/or obtains the decoded image block by combining the residual block and the predicted block obtained by prediction in the decoder. Image block prediction by the encoder or decoder can be achieved using a number of predefined prediction modes, including inter-frame prediction and intra-frame prediction. Optionally, inter-frame prediction commonly used by the encoder or decoder includes sub-block-based temporal motion vector prediction (SbTMVP).

### (II) Sub-Block-Based Temporal Motion Vector Prediction

Versatile Video Coding (VVC) supports sub-block-based temporal motion vector prediction. Similar to the temporal motion vector prediction (TMVP) in High Efficiency Video Coding (HEVC), SbTMVP uses the motion field in a collocated picture to improve the motion vector prediction and merge mode for the coding unit (CU) in the current picture. SbTMVP uses the same collocated picture used in TMVP. SbTMVP differs from TMVP in two main aspects:
TMVP predicts motion at the CU level, while SbTMVP predicts motion at the sub-CU-level.
TMVP obtains the temporal motion vector from the collocated block in the collocated picture (the collocated block is the bottom-right corner block or the center block relative to the current CU). SbTMVP applies a motion shift before obtaining temporal motion information from the collocated picture. The motion shift is obtained from the motion vector of the spatial neighboring block A1 of the current CU.

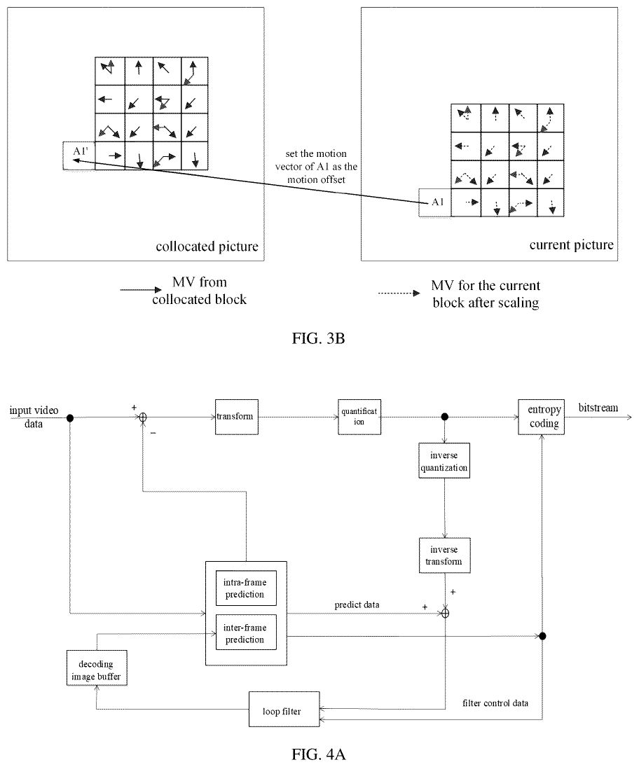

Referring to FIG. 3A and FIG. 3B, SbTMVP predicts the motion vector of a sub-CU within the current CU in two steps.

In the first step, the spatially neighboring block A1 shown in FIG. 3A is examined. If A1 has a motion vector using the collocated picture as its reference image, the motion vector is selected as the motion offset to be applied. If no such motion is identified, the motion offset is set to (0, 0).

In the second step, as shown in FIG. 3B, the motion offset identified in the first step is applied (i.e., added to the image block coordinates) to obtain sub-CU-level motion information (motion vector and reference index) from the collocated picture. The example in FIG. 3B assumes that the motion offset is set to the motion vector of the spatially neighboring block A1. Then, for each sub-CU, the motion information of its corresponding block in the collocated picture (the minimum motion grid/motion unit covering the center sample) is used to derive the sub-CU's motion information. After determining the motion information of the collocated sub-CU, it is converted into the motion vector and reference index of the current sub-CU in a manner similar to the HEVC TMVP process, where temporal motion scaling is applied to align the reference picture of the temporal motion vector with the reference picture of the current CU.

In VVC, a sub-block-based merge list containing SbTMVP candidates and affine merge candidates is used for signaling of sub-block-based merge mode. SbTMVP mode is enabled/disabled by the sequence parameter set SPS flag. If SbTMVP mode is enabled, the SbTMVP predictor is added as the first entry in the sub-block-based merge candidate list, followed by the affine merge candidates. Information about the size of the sub-block-based merge list is sent in the sequence parameter set (SPS), and/or the maximum allowed size of the sub-block-based merge list is 5 in VVC.

The sub-CU size used in SbTMVP is fixed at 8×8. Like the affine merge mode, SbTMVP mode only applies to CUs with a width and height greater than or equal to 8.

The encoding logic for additional SbTMVP merge candidates is the same as for other merge candidates: an additional rate-distortion check is performed on each CU in a P or B slice to determine whether to use the SbTMVP merge candidate.

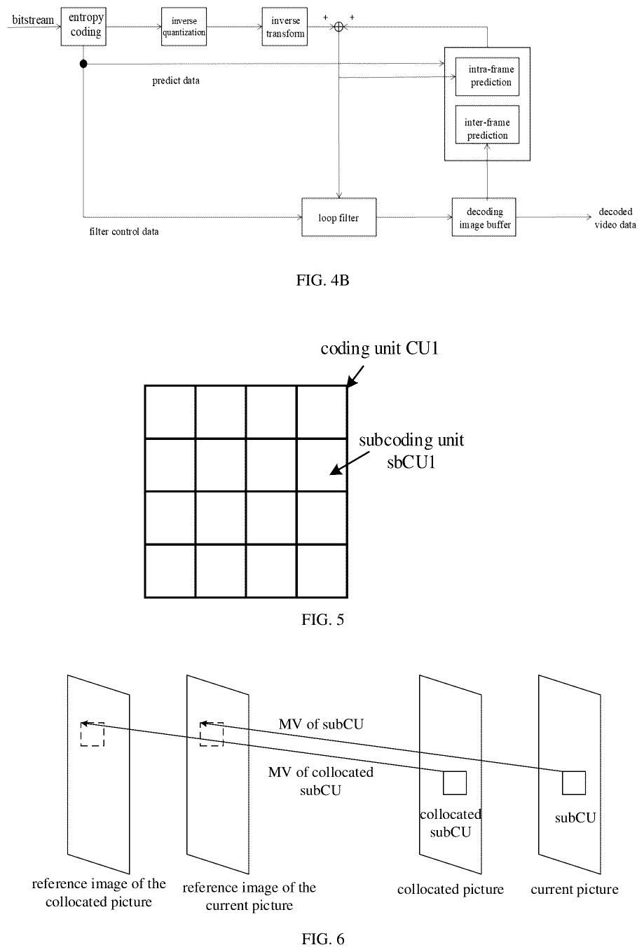

As shown in FIG. 4A and FIG. 4B, FIG. 4A is a schematic diagram of the image encoding scenario involved in the processing method provided in the present application, and FIG. 4B is a schematic diagram of the image decoding process. At the encoding end, the encoder typically divides the input video image into at least one image block for processing. Each image block can be subtracted from the prediction block predicted by the prediction mode to obtain a residual block. The residual block and the relevant parameters of the prediction mode are then subjected to a series of processing to obtain the encoded bitstream. Afterward, at the decoding end, the decoder receives the bitstream and parses it to obtain the prediction mode parameters. Furthermore, the decoder's inverse transform unit and inverse quantization unit inversely transform and inverse quantize the transform coefficients to produce a residual block. Optionally, the decoder's decoding unit parses and decodes the encoded bitstream to obtain the prediction parameters and related side information. Next, the decoder's prediction processing unit uses the prediction parameters to perform prediction processing, thereby determining the prediction block corresponding to the residual block. The decoder then reconstructs the block by adding the residual block to the corresponding prediction block. Optionally, the decoder's loop filtering unit performs loop filtering on the reconstructed block to reduce distortion and improve video quality. The loop-filtered reconstructed blocks are then combined into a decoded image, stored in a decoded image buffer, or output as a decoded video signal.

Optionally, the image processing method provided in the embodiments of the present application can be applied to scenarios involving encoding prediction of image blocks during the aforementioned video image encoding process, such as, scenarios involving inter-frame prediction during video image encoding and inter-frame prediction during video image decoding.

### First Embodiment

In this embodiment, the image processing method provided herein may be executed by the aforementioned processing device, or a cluster consisting of multiple such processing devices. The processing device may be a smart terminal (such as the aforementioned mobile terminal 100) or a server. Here, the image processing method provided herein will be described using the processing device as the executing entity in the first embodiment of the image processing method provided herein.

In this embodiment, the image processing method provided herein includes:
obtaining or determining motion information of a sub-processing unit within a unit to be processed; and
performing luminance and chrominance prediction on the unit to be processed based on the motion information to determine or obtain a prediction result for the unit to be processed.

In this embodiment, the unit to be processed may be an image block in an input video image (i.e., a video frame) that is being encoded or decoded and thus requires prediction processing. Optionally, the image block may also be referred to as an image sample, and may be simply referred to as a current block, current sample, or block to be processed. Under the H.265/High Efficiency Video Coding (HEVC) standard, the unit to be processed may be a coding tree unit (CTU) in the input video image, or a coding unit (CU). This embodiment of the application does not specifically limit the type of the unit to be processed.

After receiving a video image from a video source, the processing device, acting as an encoder, segments the video image into at least one image block (an image block includes an image coding unit and a sub-image coding unit). The processing device then utilizes temporal and/or spatial correlations between the video images to perform prediction processing on each of the at least one image block. In one embodiment, when the processing device uses an inter-frame prediction mode (particularly, sub-block-based temporal motion vector prediction) to perform prediction processing on the current picture block, it can determine that the image block is the unit to be processed. In this way, during the prediction processing of the current unit to be processed, the processing device can determine or obtain a prediction result for the unit to be processed based on the motion information of the sub-processing units within the unit to be processed.

Optionally, the processing device, acting as an encoder, may use, for example, rate-distortion optimization to determine the prediction mode ultimately adopted for each of the at least one image block. For example, the rate-distortion cost corresponding to each prediction mode may be calculated to determine the minimum rate-distortion cost from among the rate-distortion costs corresponding to the multiple prediction modes. The prediction mode corresponding to the minimum rate-distortion cost is the prediction mode ultimately adopted for the image block.

Optionally, in this embodiment, the processing device can obtain or determine the motion information of the sub-processing unit in the unit to be processed based on the collocated processing unit of the unit to be processed, the collocated sub-processing unit of the sub-processing unit in the unit to be processed, a preset sub-block merge candidate list, the value of a preset flag, the first motion offset information of the unit to be processed, and/or the second motion offset information of the first image unit or the first sub-image unit in the processed area of the image to be processed where the unit to be processed is located, and then determine or obtain a prediction result for prediction processing for the unit to be processed based on the motion information.

In an embodiment, the processing device first determines or obtains a prediction result for a sub-processing unit within the unit to be processed based on the motion information of the sub-processing unit, and then obtains or determines a prediction result for the unit to be processed based on the prediction result of the sub-processing unit. Optionally, if the unit to be processed has four sub-processing units, the processing device first obtains or determines a prediction result for each of the four sub-processing units based on their respective motion information, and then obtains or determines a prediction result for the entire unit to be processed based on the prediction results of the four sub-processing units.

After the processing device determines or obtains the prediction result for the unit to be processed on a sample-by-sample basis according to the above process, the processing device acting as an encoder can further subtract the predicted value of the corresponding pixel in the predicted image block (the chrominance prediction result or the luminance prediction result for the unit to be processed) from the sample value of the pixel in the current picture block to obtain the residual value of the pixel and the residual block corresponding to the image block. The residual block is then transformed and quantized, and then encoded by an entropy encoder to form the encoded bitstream. In addition, the encoded bitstream may also include prediction parameters corresponding to the prediction mode determined by the processing device through the above process (which are packaged into the encoded bitstream after entropy encoding) and related side information. If the determined prediction mode is sub-block-based temporal motion vector prediction (SbTMVP), the above prediction parameters include information indicating the sub-block-based temporal motion vector prediction (SbTMVP).

Optionally, the transformed and quantized residual block is added to the corresponding prediction block obtained using the prediction mode to obtain a reconstructed block. After obtaining the reconstructed block, the processing device also performs loop filtering on the reconstructed block to reduce distortion. After loop filtering, the processing device can also store the resulting reconstructed image in a coded image buffer so that the reconstructed image can be used for subsequent inter-frame prediction processing.

Optionally, when the processing device acts as a decoder, it can receive the encoded bit stream transmitted by the processing device acting as an encoder. After the processing device acts as a decoder and receives the bit stream encoded by the encoder, the decoding unit of the decoder parses and decodes the bit stream to obtain prediction parameters. Optionally, the inverse transform unit and inverse quantization unit of the decoder perform inverse transform and inverse quantization on the transform coefficients to obtain a residual block. Next, the prediction processing unit of the decoder can treat the residual block as the current processing unit that needs to be decoded and perform prediction processing using the prediction parameters, thereby determining the prediction block corresponding to the residual block.

Optionally, when the decoder uses the same inter-frame prediction mode as that used by the encoder, the decoder may perform prediction processing using the prediction parameters obtained by parsing the bitstream, thereby determining the prediction block corresponding to the residual block. Optionally, the prediction processing includes intra-frame prediction processing and/or inter-frame prediction processing, and/or the intra-frame prediction processing and/or inter-frame prediction processing include at least one prediction mode. For example, based on the indication information in the parsed bitstream, the decoder determines that the prediction mode used for the image block is sub-block-based temporal motion vector prediction. In this way, the decoder can use the sub-block-based temporal motion vector prediction to obtain the prediction block corresponding to the image block.

Optionally, after determining or obtaining the prediction result for the unit to be processed on a sample-by-sample basis, the processing device acting as a decoder may further add the residual block obtained through parsing to the predicted values of the corresponding pixels in the predicted image block (the chrominance prediction result or the luminance prediction result for the unit to be processed) to obtain a reconstructed block. Finally, the processing device performs loop filtering on the reconstructed block via a loop filtering unit to reduce distortion and improve video quality. The loop-filtered reconstructed blocks are then combined into a decoded image, which is stored in a decoded image buffer or output as a decoded video signal.

Optionally, since the sub-CU size in sub-block-based temporal motion vector prediction is fixed at 8×8, and, like the affine merge mode, the SbTMVP mode is only used when the CU width and height are both greater than or equal to 8, during the sub-block-based temporal motion vector prediction process, the processing device further divides the CU to be processed into at least one sub-processing unit. For example, a CU to be processed may be divided into 8×8 subcoding units. Optionally, the processing device may further divide other coding blocks into at least one other sub-image block. Optionally, referring to FIG. 5, assuming the CU to be processed is CU1, the illustrated subcoding unit sbCU1 is a sub-processing unit within CU1. CU1 includes 16 subcoding units sbCU1 of equal size.

Optionally, after further dividing the processing unit (CU) into at least one sub-processing unit (sbCU), the processing device calculates motion information (e.g., motion vector) for each sub-processing unit. After calculating and determining the motion information for each sub-processing unit, the processing device may begin performing inter-frame prediction on the sub-processing unit to obtain a sub-prediction block for the sub-processing unit. The processing device then determines or obtains a prediction unit (or prediction block) for the entire CU based on the obtained sub-prediction blocks of all sub-processing units, and then performs subsequent encoding or decoding processing.

Optionally, when the processing device performs prediction processing on the unit to be processed based on the sub-block temporal motion vector prediction technology, it can also combine other intra-frame and/or inter-frame prediction technologies to perform encoding and decoding processing.

In this embodiment, the present application provides an image processing method, the processing device performs prediction processing on the unit to be processed based on inter-frame prediction, and in this process, divides the unit to be processed into at least one sub-processing unit, and calculates and determines motion information of the sub-processing unit, so as to determine or obtain the prediction result of the entire unit to be processed based on the motion information of the sub-processing unit in the unit to be processed, that is, the sub-prediction blocks of all sub-processing units are obtained based on the motion information of each sub-processing unit in the unit to be processed, and then determine or obtain the prediction unit (or prediction block) of the entire unit to be processed. In this way, the trajectory represented by the motion offset parameters determined for the unit to be processed during the image encoding and decoding process can be kept consistent or similar to the actual motion trajectory of the unit to be processed, thereby effectively improving the prediction accuracy and/or efficiency of video encoding.

### Second Embodiment

In this embodiment, the image processing method provided in the present application may still be executed by the aforementioned processing device. In this embodiment, when the processing device uses inter-frame prediction to predict the unit to be processed, the sub-processing unit may optionally be located in the current picture, which is the image to be encoded/decoded, and the collocated sub-processing unit may be located in the collocated picture of the current picture. The motion information of the sub-processing unit may be motion offset information, which is used to indicate the positional offset between the sub-processing unit and the collocated sub-processing unit.

Optionally, if the position of the sub-processing unit in the current picture is (x, y), and/or the position offset between the sub-processing unit and the collocated sub-processing unit is 0, then the position of the collocated sub-processing unit in the collocated picture of the current picture is also (x, y). Optionally, if the position of the sub-processing unit in the current picture is (x, y), and/or the position offset between the sub-processing unit and the collocated sub-processing unit is (−1, −1), then the position of the collocated sub-processing unit in the collocated picture of the current picture is (x−1, y−1). Optionally, the above-mentioned position offset can be represented by a motion vector.

Optionally, referring to FIG. 6, during encoding or decoding processing by the processing device, the current picture is the image currently being encoded or decoded, and the collocated picture is the image that has been encoded or decoded and is temporally adjacent to the current picture. Optionally, when constructing a sub-block-based merge candidate list and an Advanced Motion Vector Prediction (AMVP) candidate list, the two reference images with the smallest distance in their picture order number (POC) from the current picture are designated as the collocated pictures of the current picture. Optionally, the picture order number (POC), also known as the picture sequence number, is primarily used to identify the playback order of images and is also used to mark the initial picture sequence number of the reference image when decoding an image block using inter-frame prediction.

Optionally, the processing device at the encoding end may also specify a collocated picture for the current picture based on predefined rules. Optionally, the rules that the processing device may use may be defined based on the specific design requirements of the actual application, and the image processing method provided in the present application is not limited to the specific content of such rules.

Optionally, the aforementioned collocated sub-processing unit is a sub-processing unit that is located at the same position as the sub-processing unit in the collocated picture. Optionally, if the collocated sub-processing unit is located at the same position as the sub-processing unit in the collocated picture, then when the sub-processing unit position is (x0, y0), the collocated sub-processing unit position is also (x0, y0).

Optionally, the aforementioned collocated sub-processing unit is a sub-processing unit corresponding to the sub-processing unit's position in the collocated picture. Optionally, if a sub-processing unit sbCU0′ exists in the collocated picture and its characteristics are similar to those of the sub-processing unit sbCU0 of the unit to be processed in the current picture, the processing device may designate the sub-processing unit sbCU0′ as the collocated sub-processing unit of sub-processing unit sbCU0.

Optionally, in this embodiment, the motion information of the aforementioned sub-processing unit may be obtained or determined using at least one of the following methods:

First method: obtaining or determining the motion information based on the collocated processing unit of the unit to be processed.

Optionally, when calculating and determining the motion information of any sub-processing unit within the unit to be processed, if the processing device can calculate and determine the motion information of a collocated processing unit within the entire unit to be processed, the processing device may directly use the motion information of the unit to be processed as the motion information of the sub-processing unit.

Optionally, the processing device may calculate and determine the motion information of the collocated unit to be processed based on the motion vectors corresponding to the adjacent area, the neighboring area, the adjacent sample, and/or the neighboring sample of the unit to be processed in the current picture.

Second method: obtaining or determining the motion information based on the collocated sub-processing unit of the sub-processing unit.

Optionally, when calculating and determining the motion information of any sub-processing unit within the unit to be processed, if the processing device can calculate and determine the motion information of a collocated sub-processing unit of the sub-processing unit, the processing device may directly use the motion information of the collocated sub-processing unit as the motion information of the sub-processing unit.

Optionally, the processing device may calculate and determine the motion information of the collocated sub-processing unit based on the motion vectors corresponding to the adjacent area, the neighboring area, the adjacent sample, and/or the neighboring sample of the unit to be processed in the current picture.

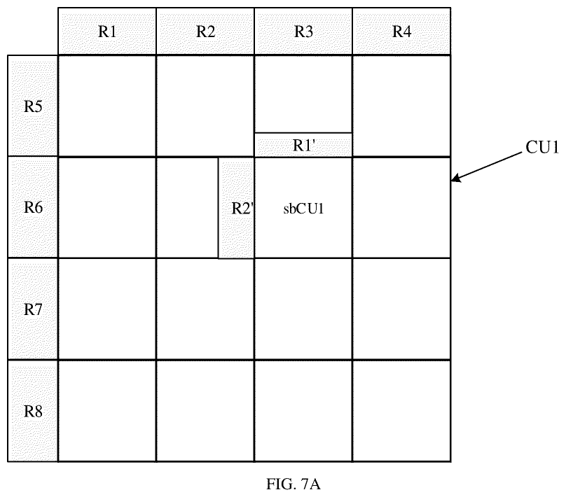

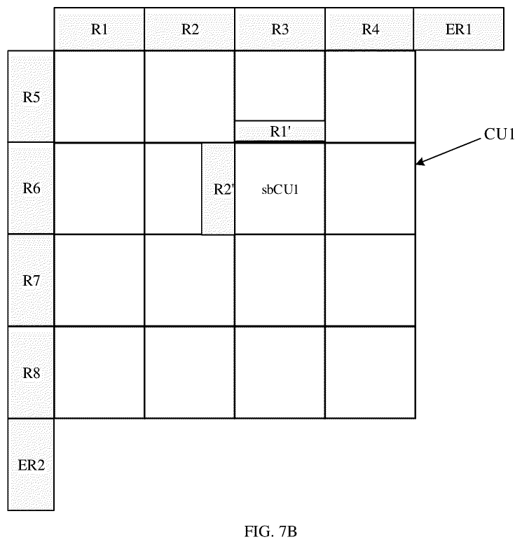

As shown in FIG. 7A and FIG. 7B, In FIG. 7A, R1-R8 are neighboring areas of the unit to be processed CU1. R1′ and R2′ are neighboring areas of the sub-processing unit sbCU1. Optionally, the neighboring area can be composed of at least one row or at least one column of pixel samples. The technical solution of the present application specifically limits the shape of the neighboring area. Optionally, in FIG. 7A, the upper neighboring area of the unit to be processed CU1 includes four areas of the same size and shape, namely R1-R4, and the left neighboring area of the unit to be processed CU1 also includes four areas of the same size and shape, namely R5-R8. Optionally, the neighboring area of the unit to be processed CU1 can also include areas of other numbers and shapes. The neighboring area can also be located on the upper right and upper left of the unit to be processed (such as the neighboring area ER1 and the adjacent area ER2 in FIG. 7B).

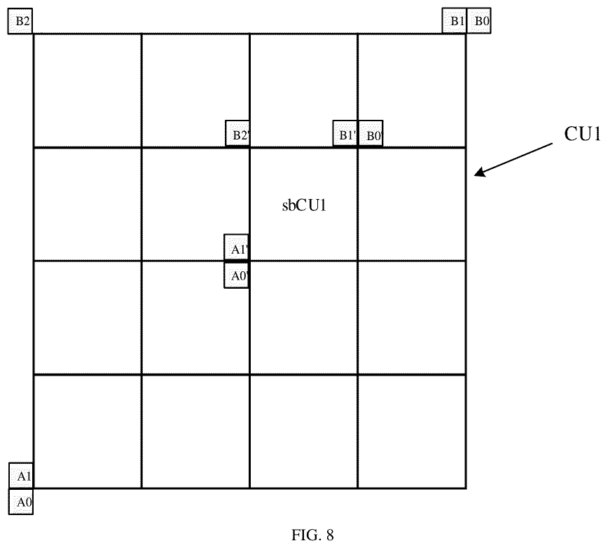

Optionally, referring to FIG. 8, the neighboring samples of the processing unit and the sub-processing unit are pixel samples adjacent to the processing unit and the sub-processing unit. As shown in FIG. 8, A0, A1, B0, B1, and B2 are the lower left neighboring sample, left neighboring sample, upper right neighboring sample, upper neighboring sample, and upper left neighboring sample of the processing unit CU1, while A0′, A1′, B0′, B1′, and B2′ are the lower left neighboring sample, left neighboring sample, upper right neighboring sample, upper neighboring sample, and upper left neighboring sample of the sub-processing unit sbCU1.

Optionally, the aforementioned adjacent area is similar to the neighboring area.

Optionally, the adjacent area is an area located close to the processing unit but not adjacent to the unit to be processed.

Optionally, the adjacent area is N samples away from the processing unit, where N can be 1 to 4 samples.

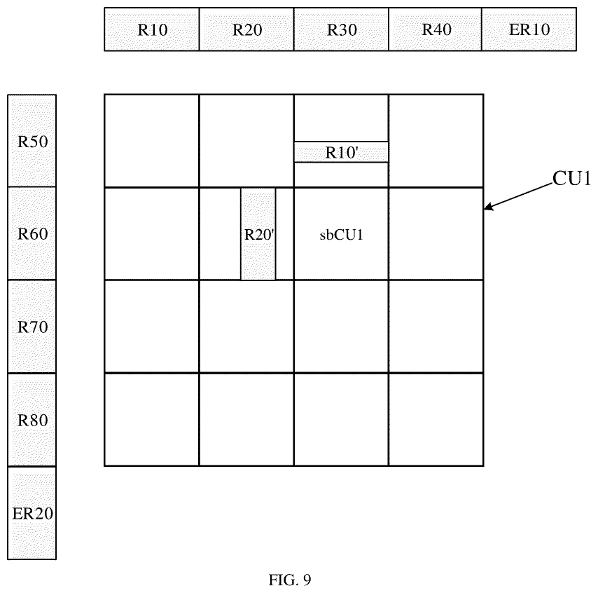

As shown in FIG. 9, the unit to be processed and the adjacent areas R10 to R80 and ER10 to ER20 are not adjacent but are at a certain distance from each other. Similarly, the sub-processing unit and the adjacent areas R10′ to R20′ are not adjacent but are at a certain distance from each other. Optionally, there may be several rows or columns of pixel samples between the unit to be processed and the adjacent areas; there may be several rows or columns of pixel samples between the sub-processing unit and the adjacent areas. Optionally, there is also a certain distance between the unit to be processed and the adjacent samples. Optionally, there is also a certain distance between the sub-processing unit and the adjacent samples. Optionally, there may be one or more pixel samples between the unit to be processed and the adjacent samples; there may be one or more pixel samples between the sub-processing unit and the adjacent samples.

Optionally, after the processing device obtains or determines the adjacent area, the neighboring area, the adjacent sample or the neighboring sample of the unit to be processed or the sub-processing unit as shown in FIGS. 7A, 7B, 8 and/or 9, the processing device can calculate and determine the motion vectors corresponding to the adjacent area, the neighboring area, the adjacent sample or the neighboring sample, and then determine the motion information of the sub-processing unit in the sub-unit to be processed based on these motion vectors, that is, calculate and determine the motion vector of the sub-processing unit based on these motion vectors.

Optionally, when determining the adjacent area, the neighboring area, the adjacent sample or the neighboring sample of the processing unit or sub-processing unit, the processing device may also select the adjacent area or the adjacent sample to obtain a more appropriate motion vector as the motion information of the sub-processing unit if the determined neighboring area or the neighboring sample is unavailable. Therefore, compared to determining the neighboring area or the neighboring sample, the processing device provides greater flexibility in determining the adjacent area or the adjacent sample.

Optionally, the aforementioned samples refer to pixel samples in the current picture.

Third method: obtaining or determining the motion information based on a preset sub-block merge candidate list.

Optionally, when calculating and determining the motion information of any sub-processing unit in the unit to be processed, the processing device may further use a candidate motion vector (or motion vector predictor) corresponding to a preset sub-block merge candidate list as the motion information of the sub-processing unit. Optionally, the motion information corresponds to the first entry in the sub-block merge candidate list.

Optionally, the processing device can use an array to construct a sub-block merge candidate list. For example, the processing device sets the sub-block merge candidate list subblockMergeCandList[i](i=0, 1, . . . , n. n is the number of entries in the list). The sub-block merge candidate list subblockMergeCandList[i] is an array. Then, the processing device associates the sub-block merge candidate list subblockMergeCandList[0] with the motion vector of the collocated processing unit of the unit to be processed, or with the motion vector of the collocated sub-processing unit of the sub-processing unit, and/or associates subblockMergeCandList[1]-subblockMergeCandList[n] with the motion vectors of other candidates. In this way, when the above-mentioned association action is completed, the processing device constructs the sub-block merge candidate list.

Optionally, the sub-block merge candidate list subblockMergeCandList[i] is associated with the motion vector of the collocated processing unit of the unit to be processed, or the motion vector of the collocated sub-processing unit of the sub-processing unit, meaning that when the sub-block merge candidate list subblockMergeCandList[0] is selected, the motion vector of the collocated processing unit of the unit to be processed, or the motion vector of the collocated sub-processing unit of the sub-processing unit is used as the motion information of the sub-processing unit.

Optionally, the processing device can associate the motion information of the sub-processing unit with the first entry in the sub-block merge candidate list, thereby giving the technical solution of the present application a higher priority than motion vectors obtained by other methods, thereby improving the utilization efficiency and, in turn, improving the efficiency of encoding and decoding video images.

Fourth method: obtaining or determining the motion information based on a preset flag.

Optionally, when calculating and determining the motion information of any sub-processing unit in the unit to be processed, the processing device may further use a preset flag to directly determine the motion information (mvL0SbCol[xSbIdx][ySbIdx]) of the collocated sub-processing unit of the sub-processing unit as the motion information of the sub-processing unit. Optionally, the processing device may further use the preset flag to directly determine the motion information (ctrMvLX) of the collocated processing unit of the unit to be processed as the motion information of the sub-processing unit.

Optionally, the fourth method described above may include:
if the preset flag is a first value, obtaining or determining the motion information of the sub-processing unit based on the motion information of a collocated sub-processing unit; and/or
if the preset flag is a second value, obtaining or determining the motion information of the sub-processing unit based on the motion information of a center sample of a collocated processing unit of the unit to be processed.

Optionally, the preset flag includes a first value and/or a second value. Based on this, when the processing device determines, through analysis, that the preset flag is the first value, it can directly determine the motion information (mvL0SbCol[xSbIdx][ySbIdx]) of the collocated sub-processing unit of the sub-processing unit as the motion information of the sub-processing unit. Furthermore, when the processing device determines, through analysis, that the preset flag is the second value, it can directly determine the motion information (ctrMvLX) of the collocated processing unit of the unit to be processed as the motion information of the sub-processing unit.

Optionally, the motion information (ctrMvLX) of the collocated processing unit of the unit to be processed may be the motion information of the center sample of the collocated processing unit.

Optionally, when determining the motion information of any sub-processing unit within the unit to be processed, if the processing device determines that the prediction mode used by the collocated sub-processing unit of the sub-processing unit is intra-coding mode, palette coding mode, or intra-block copy mode (IBC), the processing device determines that the motion information of the current collocated sub-processing unit cannot be directly used as the motion information of the sub-processing unit, or that the collocated sub-processing unit does not actually have motion information. In this case, the processing device may determine the motion information of the sub-processing unit based on the motion information of the collocated processing unit of the unit to be processed (e.g., the motion information of the center sample of the collocated processing unit).

Optionally, when the motion information of the collocated sub-processing unit is unavailable or does not exist, the processing device sets the preset flag to a first value (e.g., “0”). Thus, upon parsing and determining that the preset flag value is “0,” the processing device can directly determine the motion information (ctrMvLX) of the collocated processing unit of the unit to be processed as the motion information of the sub-processing unit.

Fifth method: obtaining or determining the motion information based on the first motion offset information of the unit to be processed.

Optionally, when calculating and determining the motion information of any sub-processing unit within the unit to be processed, if the processing device can directly calculate and determine the first motion offset information of the unit to be processed, the processing device can determine the collocated sub-processing unit of the sub-processing unit based on the first motion offset information of the unit to be processed, thereby obtaining or determining the motion information of the sub-processing unit based on the collocated sub-processing unit.

Optionally, the first motion offset information of the unit to be processed may be a motion vector.

Sixth method: obtaining or determining the motion information based on the second motion offset information of the first image unit or first sub-image unit in the processed area of the image to be processed.

Optionally, when calculating and determining the motion information of any sub-processing unit in the unit to be processed, the processing device can also determine at least one first image unit or at least one first sub-image unit in the processed area of the image to be processed where the above-mentioned unit to be processed is located, and then obtain or determine the motion information of the sub-processing unit in the unit to be processed based on the second motion offset information of the first image unit or the first sub-image unit.

Optionally, the second motion offset information may be a motion vector. The motion vector may be determined by the processing device based on matching costs derived from first image units or first sub-image units in a processed area of the current picture to be processed. According to an embodiment, the motion vector of the first image unit or first sub-image unit corresponding to the minimum matching cost among the matching costs derived from at least one first image unit or first sub-image unit may be determined as the motion vector.

Optionally, the above-mentioned second motion offset information can be determined based on the matching cost derived from at least one first area or at least one first sample of the first image unit in the processed area of the current picture; or, the second motion offset information can also be determined based on the matching cost derived from at least one second area or at least one second sample of the first sub-image unit.

Optionally, the second motion offset information includes motion information of at least one third area in the first image unit or motion information of at least one first sample in the first image unit. Optionally, the motion information of the at least one third area or the motion information of the at least one first sample in the first image unit corresponds to the minimum matching cost of the first image unit.

Optionally, the second motion offset information includes motion information of at least a fourth area in a first sub-image unit of the first image unit, or motion information of at least a second adjacent sample of the first sub-image unit. Optionally, the motion information of the at least fourth area or the motion information of the at least second adjacent sample corresponds to a minimum matching cost of the first sub-image unit.

Optionally, if motion information corresponding to the at least one first area, at least one second area, the third area, the fourth area, the first sample, and/or the second sample is unavailable, the processing device may directly determine the second motion offset information as a zero vector.

Optionally, the at least one first sample includes at least one of a lower-left adjacent sample and an upper-right adjacent sample of the first image unit. Optionally, the at least one second adjacent sample includes at least one of a lower-left adjacent sample and an upper-right adjacent sample of the first sub-image unit.

Optionally, when the processing device determines that the central sub-block and/or central sample of the first image unit adopts unidirectional prediction, the processing device also determines the first motion offset information as a motion vector for unidirectional prediction. Optionally, when the processing device determines that the central sub-block and/or central sample of the first image unit adopts bidirectional prediction, the processing device also determines the first motion offset information as motion information for bidirectional prediction. Optionally, when the processing device determines that a sub-image unit adjacent to the first neighboring area/neighboring sample in the first image unit uses unidirectional prediction, the processing device also determines the first motion offset information as a motion vector for unidirectional prediction. Optionally, when the processing device determines that a sub-image block adjacent to the first neighboring area/neighboring sample in the first image unit uses bidirectional prediction, the processing device determines the first motion offset information as motion information for bidirectional prediction.

Seventh method: obtaining or determining the motion information based on a combination of at least one second motion offset information.

Eighth method: obtaining or determining the motion information based on a motion vector prediction candidate list.

Optionally, the motion information of the sub-processing unit can be obtained or determined from a motion vector prediction candidate list (also called an MVP list). For example, the motion vector prediction candidate list used to determine the motion information of the sub-processing unit includes multiple motion vector predictors. These motion vector predictors can correspond to motion offsets in the motion offset information list. For example, these motion vector predictors may be motion vector predictors mvp0, mvp1, and mvp2. Motion vector predictor mvp0 is determined by motion offset candidate 0 in the motion offset information list; motion vector predictor mvp1 is determined by motion offset candidate 1 in the motion offset information list; and motion vector predictor mvp2 is determined by motion offset candidate 2 in the motion offset information list.

Optionally, the motion information of the sub-processing unit may be a motion vector predictor obtained or determined from a motion vector prediction candidate list (also referred to as an MVP list). In another embodiment, the motion information of the sub-processing unit may be determined using a motion vector predictor obtained or determined from a motion vector prediction candidate list (also referred to as an MVP list) and a motion vector difference (MVD).

Optionally, the first through eighth methods can be combined with each other. For example, the first method can be combined with the second method. In one embodiment of the present application, a collocated processing unit of the unit to be processed obtains or determines motion vector predictor 1, and a collocated sub-processing unit of the sub-processing unit determines motion vector predictor 2. Motion information of the sub-processing unit is then determined using motion vector predictor 1 and motion vector predictor 2.

The first method can be combined with the third method. In an embodiment of the present application, a motion vector predictor 1 is obtained or determined by a collocated processing unit of the unit to be processed. Then, the motion vector predictor 1 is used as a candidate motion vector or motion vector predictor in the sub-block merge candidate list, and the motion information of the sub-processing unit is further determined based on the sub-block merge candidate list.

The second method can be combined with the third method. In an embodiment of the present application, the motion vector predictor 2 is obtained or determined by the collocated sub-processing unit of the sub-processing unit. The motion vector predictor 2 is then used as a candidate motion vector or motion vector predictor in the sub-block merge candidate list, and the motion information of the sub-processing unit is further determined based on the sub-block merge candidate list.

The first method and the fourth method can be combined. For example, if the preset flag is the second value, the motion information of the sub-processing unit is obtained or determined based on the motion information of the center sample of the collocated processing unit of the processing unit to be processed.

The second method and the fourth method can be combined. For example, if the preset flag is the first value, the motion information of the sub-processing unit is obtained or determined based on the motion information of the collocated sub-processing unit of the sub-processing unit.

The first method can be combined with the eighth method. In an embodiment of the present application, motion vector predictor 1 is obtained or determined by a collocated processing unit of the processing unit. Motion vector predictor 1 is then used as a motion vector predictor in a motion vector predictor candidate list, and motion information of the sub-processing unit is further determined based on the motion vector predictor candidate list.

The second method can be combined with the eighth method. In an embodiment of the present application, motion vector predictor 2 is obtained or determined by a collocated sub-processing unit of the sub-processing unit. Motion vector predictor 2 is then used as a motion vector predictor in a motion vector predictor candidate list, and motion information of the sub-processing unit is further determined based on the motion vector predictor candidate list.

The fifth method can be combined with the eighth method. That is, in an embodiment of the present application, the first motion offset information is obtained and determined from a motion offset information list, and the motion information of the sub-processing unit is obtained or determined from a motion vector prediction candidate list (also known as an MVP list). Furthermore, the motion vector predictor in the motion vector prediction candidate list is determined using the motion offset candidates in the motion offset information list.

The sixth method can be combined with the fifth method. For example, the first motion offset information is determined based on the second motion offset information of the first image unit or the first sub-image unit in the processed area of the image to be processed. Further, the motion information is obtained or determined based on the first motion offset information. For another example, the first motion offset information is determined based on the second motion offset information of the first image unit or the first sub-image unit in the processed area of the image to be processed. The first motion offset information is a motion offset candidate in the motion offset information list. Further, the motion information of the sub-processing unit is obtained or determined based on the first motion offset information.

The sixth method can be combined with the seventh method. For example, multiple pieces of second motion offset information corresponding to multiple first image units and/or multiple first sub-image units in a processed area of the image to be processed are determined. Furthermore, appropriate motion offset information is determined from the multiple pieces of second motion offset information, and motion information of the sub-processing unit is determined based on the appropriate motion offset information.

The sixth method may be combined with the eighth method. For example, based on second motion offset information of a first image unit or a first sub-image unit in a processed area of the image to be processed, a motion vector predictor is determined from a motion vector prediction candidate list based on the second motion offset information. Furthermore, motion information of the sub-processing unit is determined based on the determined motion vector predictor.

The sixth method can be combined with the fifth, seventh, and eighth methods. For example, multiple pieces of second motion offset information corresponding to multiple first image units and/or multiple first sub-image units in a processed area of the image to be processed are determined. The multiple pieces of second motion offset information are used to construct a motion offset information list. Further, a suitable motion offset is determined from the motion offset information list. Finally, based on the suitable motion offset, a corresponding motion vector predictor is determined from the motion vector prediction candidate list to determine the motion information of the sub-processing unit.

The above combinations are not exhaustive. Embodiments of the present application may also include other combinations of the first through eighth embodiments.

Optionally, when calculating and determining the motion information of any sub-processing unit within the unit to be processed, the processing device may, after obtaining or determining the aforementioned second motion offset information, obtain or determine the motion information of the sub-processing unit within the unit to be processed based on a combination of the at least one second motion offset information.

Optionally, the processing device may select at least one second motion offset information from the at least one second motion offset information and combine the selected second motion offset information according to the positional relationship between the processed area corresponding to the at least one second motion offset information and the collocated sub-processing unit.

In this embodiment, the processing device uses the motion offset information corresponding to the minimum matching cost to determine the motion offset (or candidate motion offset) of the unit to be processed in the current picture, to reduce the error relative to the motion trajectory of the unit to be processed obtained from the motion offset (characterized by the temporal motion vector of the unit to be processed obtained from the motion offset). Specifically, suitable motion offset information is determined from at least one piece of motion offset information of the template image block, and then a suitable area/sample is selected from the adjacent area, the neighboring area, the adjacent sample, and/or the neighboring sample corresponding to the unit to be processed, so that the motion offset information corresponding to the suitable area/suitable sample is used as the motion offset information of the unit to be processed, and the sub-processing block in the unit to be processed is predicted using the motion offset information, thereby improving the prediction accuracy and/or efficiency of video encoding.

### Third Embodiment

In this embodiment, the image processing method provided in the present application can still be executed by the aforementioned processing device. In this embodiment, the second method for obtaining or determining motion information based on a collocated sub-processing unit can include:
determining the collocated sub-processing unit based on the position information and the motion offset information of the sub-processing unit; and
obtaining or determining the motion information of the sub-processing unit based on the position information of the collocated sub-processing unit and/or the motion information of the center sample of the collocated sub-processing unit.

Optionally, when determining the motion information of a sub-processing unit based on the motion information of the above-mentioned collocated sub-processing unit, the processing device may first determine the collocated sub-processing unit based on the position information and the motion offset information of the sub-processing unit; then, determine the position information of the collocated sub-processing unit and/or the motion information of the center sample of the collocated sub-processing unit, thereby obtaining or determining the motion information of the sub-processing unit based on the position information of the collocated sub-processing unit and/or the motion information of the center sample of the collocated sub-processing unit.

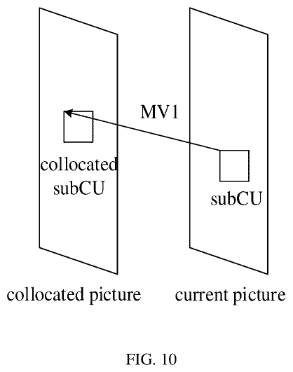

Optionally, as shown in FIG. 10, for the sub-processing unit in the current picture (the sub-CU shown in FIG. 10), if the motion vectors corresponding to the above-mentioned neighboring areas, adjacent areas, neighboring samples, and adjacent samples are used as the motion vector MV1 in FIG. 10, then based on the motion vector MV1 and the position of the sub-CU, a collocated sub-CU can be determined in the collocated picture of the current picture (the collocated sub-CU is the collocated sub-processing unit of the sub-processing unit).

Optionally, the fifth method of obtaining or determining motion information based on the first motion offset information of the processing unit may include:
obtaining or determining the first motion offset information based on at least one of the first motion information corresponding to at least one of at least one adjacent area, at least one neighboring area, at least one adjacent sample, or at least one neighboring sample; and
obtaining or determining the motion information of the sub-processing unit based on the first motion offset information.

Optionally, when determining the motion information of a sub-processing unit based on the first motion offset information of the unit to be processed, the processing device may first obtain or determine the first motion offset information based on at least one corresponding first motion information of at least one adjacent area, at least one neighboring area, at least one adjacent sample, or at least one neighboring sample of the unit to be processed; and then determine the collocated sub-processing unit based on the first motion offset information to obtain or determine the motion information of the sub-processing unit.

Optionally, the first motion offset information may be motion offset information determined by obtaining from a motion offset information list. Multiple motion offset candidates may be determined by at least one corresponding first motion information of at least one adjacent area, at least one neighboring area, at least one adjacent sample, or at least one neighboring sample. For example, these first motion information may be used as motion offset candidates. Furthermore, these motion offset candidates are used to construct a motion offset information list. That is, the elements in the motion offset information list include motion offset candidates. In addition, the motion offset candidate may also be a motion offset used by an already encoded image block (i.e., historical motion offset information) or may be a motion vector predictor (MVP) used by an already encoded image block.

Optionally, the at least one adjacent area includes at least one of a lower left adjacent area or an upper right adjacent area of the unit to be processed. The at least one adjacent sample includes at least one of a lower left adjacent sample or an upper right adjacent sample of the unit to be processed. The at least one adjacent area includes at least one of a lower left adjacent area or an upper right adjacent area of the unit to be processed.

Optionally, obtaining or determining the motion information of a sub-processing unit based on the first motion offset information may include:
determining a collocated sub-processing unit based on the position information of the sub-processing unit and the first motion offset information; and
obtaining or determining the motion information of the sub-processing unit based on the position information and/or the motion information of the collocated sub-processing unit.

Optionally, when determining a collocated sub-processing unit based on the first motion offset information to obtain or determine the motion information of the sub-processing unit, the processing device first determines a collocated sub-processing unit of the sub-processing unit based on the first motion offset information and the position information of the sub-processing unit. Then, the processing device acquires or determines the motion information of the sub-processing unit based on the position information and/or the motion information of the collocated sub-processing unit.

Optionally, the above-mentioned first motion offset information can be a motion vector MVa corresponding to at least one of the adjacent area, the neighboring area, the adjacent sample, and the neighboring sample as shown in FIGS. 7A, 7B, 8 and/or 9. The processing device can determine the collocated sub-processing unit of the sub-processing unit based on the motion vector MVa and the position information of the sub-processing unit.

Optionally, assuming the aforementioned motion vector MVa is (xa, ya) and the position of the sub-processing unit of the unit to be processed in the current picture is (x0, y0), the processing device can determine, based on the motion vector MVa and the position (x0, y0), the position of the collocated sub-processing unit of the sub-processing unit as (x0+xa, y0+ya). That is, the motion vector MVa indicates that, in the reference image (the collocated picture of the current picture), an area is determined as the collocated sub-processing unit, with the position (x0+xa, y0+ya) as the base point. Optionally, the size and aspect ratio of the collocated sub-processing unit are the same as those of the sub-processing unit.

Optionally, the sub-processing unit position (x0, y0) is the location of the sample at the upper left corner of the sub-processing unit.

Optionally, after determining the collocated sub-processing unit of the sub-processing unit based on the first motion offset information, the processing device may further obtain or determine the motion vector of the sub-processing unit based on the position information and/or the motion vector of the collocated sub-processing unit.

Optionally, when determining the motion vector of the sub-processing unit in the current picture based on the position information of the collocated sub-processing unit, the processing device first determines the center sample of the collocated sub-processing unit. Then, if the center sample uses inter-frame prediction, the processing device directly uses the motion vector corresponding to the center sample as the motion vector or motion vector candidate of the sub-processing unit of the unit to be processed in the current picture.

Optionally, assuming the position of the collocated sub-processing unit is (x0+xa, (y0+ya) and the size of the collocated sub-processing unit is s1*s1, the processing device can determine that the center sample of the collocated sub-processing unit is ((x0+xa)+s1/2, (y0+ya)+s1/2).

Optionally, assuming the position of the collocated sub-processing unit is (x0+xa, y0+ya) and the size of the collocated sub-processing unit is H1*W1, the processing device can determine that the center sample of the collocated sub-processing unit is ((x0+xa)+H1/2, (y0+ya)+W1/2).

Optionally, when the above-mentioned first motion offset information is at least one corresponding motion vector MVa of the adjacent area, neighboring area, adjacent sample, and neighboring sample as shown in FIGS. 7A, 7B, 8 and/or 9, the motion vector MVa can specifically be the motion vector used when the adjacent area, neighboring area, adjacent sample, and neighboring sample perform inter-frame prediction.

Optionally, when the processing device determines the collocated sub-processing unit of the sub-processing unit based on the motion vector MVa and the position of the sub-processing unit, if the position of the sub-processing unit of the unit to be processed in the current picture is (x′0, y′0) (the position (x′0, y′0) of the sub-processing unit is the position of the sample at the upper left corner of the sub-processing unit), the processing device may determine the position of the center sample of the sub-processing unit based on the position (x′0, y′0) of the sub-processing unit. Thereafter, the processing device may determine the position information of the collocated sub-processing unit based on the position of the center sample of the sub-processing unit and the motion vector MVa.

Optionally, if the size of the sub-processing unit is s′1*s′1, the processing device may determine the position of the center sample of the sub-processing unit to be (x′0+s′1/2, y′0+s′1/2). Optionally, if the size of the sub-processing unit is H′1*W′1, the processing device may determine the position of the center sample of the sub-processing unit to be (x′0+H′1/2, y′0+W′1/2). Optionally, H′1 is the height of the subcoding unit, and W′1 is the width of the subcoding unit.

Optionally, if the processing device determines the position of the center sample of the sub-processing unit as (x′0+s′1/2, y′0+s′1/2) and the motion vector MVa is (x′a, y′a), the processing device can determine the position of the center sample of the collocated sub-processing unit of the sub-processing unit as ((x′0+x′a)+s′1/2, (y′0+y′a)+s′1/2).

Optionally, if the processing device determines the position of the center sample of the sub-processing unit as (x′0+H′1/2, y′0+W′1/2) and the motion vector MVa is (x′a, y′a), the processing device can determine the position of the center sample of the collocated sub-processing unit of the sub-processing unit as ((x′0+x′a)+H′1/2, (y′0+y′a)+W′1/2).

Optionally, when obtaining or determining motion information of the sub-processing unit in the unit to be processed based on the collocated processing unit of the unit to be processed, the processing device first determines the collocated processing unit of the unit to be processed based on the position information of the sub-processing unit and at least one corresponding motion vector MVa in the adjacent area, neighboring area, adjacent sample, or neighboring sample as shown in FIGS. 7A, 7B, 8, and/or 9. The motion vector of the collocated processing unit is then determined based on the position information of the collocated processing unit, and the motion vector is directly used as the motion vector or motion vector candidate of the sub-processing unit of the unit to be processed in the current picture.

Optionally, when the processing device determines the collocated processing unit of the unit to be processed based on the position information of the sub-processing unit in the unit to be processed and the motion vector MVa (the motion vector MVa is also the motion vector used when performing inter-frame prediction for the aforementioned adjacent area, neighboring area, adjacent sample, and neighboring sample), if the motion vector MVa is (xa, ya) and the position of the sub-processing unit of the unit to be processed in the current picture is (x0, y0), the processing device can determine the position of the collocated sub-processing unit of the sub-processing unit as (x0+xa, y0+ya). The processing device can then determine the position of the collocated processing unit based on the size of the collocated processing unit of the unit to be processed (the same size as the unit to be processed) and the position of the collocated sub-processing unit.

Optionally, if the size of the unit to be processed in the current picture is 16*16 and the unit to be processed includes four subcoding units of the same size, the size of each subcoding unit is 8*8. Thus, when the processing device determines that the subcoding unit in the unit to be processed is the subcoding unit located in the first row and second column, the processing device can determine, based on the above process, the position of the collocated processing unit of the unit to be processed as (x0+xa−8, y0+ya).

Optionally, when determining the motion vector of the collocated processing unit of the unit to be processed, the processing device may also use the motion vector of the center sample of the collocated processing unit as the motion vector of the collocated processing unit. In this way, when determining the center sample of the collocated processing unit, if the position of the collocated processing unit is (x0+xa−8, y0+ya) and the size of the collocated processing unit is s2*s2, the processing device can determine the center sample of the collocated processing unit as ((x0+xa−8)+s2/2, (y0+ya)+s2/2). Thereafter, if the center sample of the collocated processing unit adopts inter-frame prediction, the processing device can directly use the motion vector corresponding to the center sample as the motion vector of the collocated processing unit, and/or synchronously use the motion vector corresponding to the center sample as the motion vector or motion vector candidate of the sub-processing unit of the unit to be processed in the current picture.

### Fourth Embodiment

In this embodiment, the image processing method provided herein may still be executed by the aforementioned processing device. In this embodiment, the aforementioned sixth method for obtaining or determining motion information based on the second motion offset information of a first image unit or a first sub-image unit in a processed area of the image to be processed may include:
determining first motion offset information based on the second motion offset information, and obtaining or determining motion information of the sub-processing unit based on the first motion offset information.

Optionally, when obtaining or determining motion information of the sub-processing unit within the unit to be processed based on the second motion offset information of the first image unit or the first sub-image unit, the processing device may first determine the first motion offset information based on the second motion offset information, and then obtain or determine motion information of the sub-processing unit within the unit to be processed based on the first motion offset information.

Optionally, when determining the second motion offset information of the above-mentioned first image unit, the processing device may determine the second motion offset information based on the matching cost corresponding to at least one first area in the first image unit, that is, the motion information of the first area corresponding to the minimum matching cost among the matching costs corresponding to at least one first area is determined as the second motion offset information of the first image unit.

Optionally, assuming that the first image unit is image block A, which is an image block in the current picture that has already been encoded or decoded, and/or is adjacent to or proximate to the location of the unit to be processed that is currently being encoded or decoded. Optionally, the image block A is also referred to as a template image block.

Optionally, the processing device uses the image block A to test the most appropriate motion offset information (or motion candidate offset), and then adopts the candidate offset (i.e., the first motion offset information) corresponding to the candidate offset (i.e., the second motion offset information) of the image block A for the unit to be processed. In this manner, the processing device determines appropriate motion offset information from at least one piece of motion offset information of image block A, then selects an appropriate area from the adjacent areas or neighboring areas corresponding to the unit to be processed, and uses the motion information corresponding to the appropriate area as the motion offset information for the unit to be processed. This allows for improved image block prediction accuracy and/or video coding efficiency.

Optionally, if the candidate offset for image block A (i.e., the second motion offset information) is determined using the motion vector of the upper neighboring area r1 of image block A, then the candidate offset for the unit to be processed (i.e., the first motion offset information) may be determined using the motion vector of the upper neighboring area r1′ corresponding to the position of the upper neighboring area r1. Optionally, if the upper neighboring area r1 is the first neighboring area from left to right, adjacent to the upper of image block A, then the upper neighboring area r1′ corresponding to the position of the upper neighboring area r1 is also the first upper neighboring area of the unit to be processed.

Optionally, if the candidate offset for image block A (i.e., the second motion offset information) is determined using the motion vector of the left neighboring area r2 of image block A, then the candidate offset for the unit to be processed (i.e., the first motion offset information) can be determined using the motion vector of the left neighboring area r2′ corresponding to the position of the left neighboring area r2. Optionally, if the left neighboring area r2 is the second neighboring area from top to bottom, adjacent to the left of image block A, then the left neighboring area r2′ corresponding to the position of the upper neighboring area r2 is the second neighboring area from top to bottom, adjacent to the left of the unit to be processed.

Optionally, if the candidate offset for image block A (i.e., the second motion offset information) is determined using the motion vector of the upper adjacent area r3 of image block A, then the candidate offset for the unit to be processed (i.e., the first motion offset information) may be determined using the motion vector of the upper adjacent area r3′ corresponding to the position of the upper adjacent area r1. Optionally, if the upper adjacent area r3 is the third adjacent area from left to right, adjacent to the upper of image block A, then the upper adjacent area r3′ corresponding to the position of the upper adjacent area r3 is the third upper adjacent area of the unit to be processed.

Optionally, if the candidate offset for image block A (i.e., the second motion offset information) is determined using the motion vector of the left adjacent area r4 of image block A, then the candidate offset for the unit to be processed (i.e., the first motion offset information) may be determined using the motion vector of the left adjacent area r4′ corresponding to the position of the left adjacent area r4. Optionally, if the left adjacent area r4 is the fourth adjacent area from top to bottom, adjacent to the left of image block A, then the left adjacent area r4′ corresponding to the position of the upper neighboring area r4 is the fourth adjacent area from top to bottom adjacent to the left of the unit to be processed.

Optionally, if the candidate offset of image block A (i.e., the second motion offset information) is determined by using the motion vector of the upper neighboring sample s1 of image block A, then the candidate offset of the unit to be processed (i.e., the first motion offset information) can be determined by using the motion vector of the upper neighboring sample s1′ corresponding to the position of the upper neighboring sample s1. Optionally, if the position of image block A is (0, 0), the position of the upper neighboring sample s1 is (x, −1), and the position of the unit to be processed is (a, b), then the position of the upper neighboring sample s1′ corresponding to the position of the upper neighboring sample s1 is (a+x, b−1).

Optionally, if the candidate offset of image block A (i.e., the second motion offset information) is determined using the motion vector of the left neighboring sample s2 of image block A, then the candidate offset of the unit to be processed (i.e., the first motion offset information) can be determined using the motion vector of the left neighboring sample s2′ corresponding to the position of the left neighboring sample s2. Optionally, if the position of image block A is (0, 0), the position of the upper neighboring sample s2 is (−1, y), and the position of the unit to be processed is (a, b), then the position of the upper neighboring sample s2′ corresponding to the position of the upper neighboring sample s2 is (a−1, b+y).

Optionally, if the candidate offset of image block A (i.e., the second motion offset information) is determined by using the motion vector of the upper adjacent sample s3 of image block A, then the candidate offset of the unit to be processed (i.e., the first motion offset information) can be determined by using the motion vector of the upper adjacent sample s3′ corresponding to the position of the upper adjacent sample s3. Optionally, if the position of image block A is (0, 0), the position of the upper adjacent sample s3 is (x, −2), and the position of the unit to be processed is (a, b), then the position of the upper adjacent sample s3′ corresponding to the position of the upper adjacent sample s3 is (a+x, b−2).

Optionally, if the candidate offset of image block A (i.e., the second motion offset information) is determined using the motion vector of the left adjacent sample s4 of image block A, then the candidate offset of the unit to be processed (i.e., the first motion offset information) can be determined using the motion vector of the left adjacent sample s4′ corresponding to the position of the left adjacent sample s4. Optionally, if the position of image block A is (0, 0), the position of the upper adjacent sample s4 is (−2, y), and the position of the unit to be processed is (a, b), then the position of the upper adjacent sample s4′ corresponding to the position of the upper adjacent sample s4 is (a−2, b+y).

Optionally, the processing device may further determine appropriate motion offset information from the at least one piece of motion offset information, and then select motion offset information of the same type as the appropriate motion offset information from the at least one piece of motion offset information corresponding to the unit to be processed.

Optionally, assuming that image block A includes motion offset information X, motion offset information Y, and motion offset information Z, where motion offset information X corresponds to a motion vector sampled at the center of a first area X, motion offset information Y corresponds to a motion vector sampled at the center of the first area Y, and motion offset information Z corresponds to a motion vector sampled at the center of the first area Z. Thus, if, from the three pieces of motion offset information of image block A, motion offset information X is determined to be the motion offset information with the lowest derived matching cost, then when performing prediction processing on the unit to be processed, the processing device may use motion offset information X corresponding to the first area X of the unit to be processed as the selected motion offset information.

Optionally, when performing prediction processing on the unit to be processed based on the above process, the processing device first sets the reference image having the smallest image sequence distance with the current picture as the collocated picture of the current picture. The processing device then determines an image block A in the current picture for deriving motion offset information. The image block A is located in an already coded area of the current picture and not in the current coding unit, and/or the size of image block A is the same as the size of the unit to be processed. The processing device then sets at least one first area around the image block A. Optionally, the at least one first area is an adjacent area or a neighboring area. The processing device then determines at least one candidate motion offset based on the at least one first area. Optionally, the processing device determines center samples of the at least one first area and determines motion vectors used by these center samples. If these motion vectors point to a collocated picture, these motion vectors are used as the at least one candidate motion offset.

After determining at least one motion candidate offset, the processing device determines, for each of the at least one motion candidate offset, at least one collocated picture block A′ of image block A in the collocated picture, or determines a collocated sub-image block a′ of the at least one collocated picture A′ based on the position of image block A/sub-image block a. Optionally, the sub-image block a is a sub-image block of image block A, that is, the image block A includes the sub-image block a. Optionally, the sub-image block a is a sub-CU, and/or the sub-image block a is also located in a coded area of the current picture and not in the current coding unit.

The processing device determines at least one collocated picture block A′ of image block A in the collocated picture, or after determining the collocated sub-image block a′ of the at least one collocated picture A′, determines at least one motion vector mva of at least one sub-image block a in image block A using each of the at least one motion vector colsbmv of the at least one collocated sub-image block a′. Furthermore, the processing device uses the at least one motion vector mva to perform inter-frame prediction on the at least one sub-image block a in image block A to obtain a corresponding prediction result. Finally, the processing device compares the difference (such as SAD, SATD values representing matching costs) and/or costs (such as rate-distortion costs) between the combination of prediction results for the sub-image block corresponding to each of the at least one motion candidate offset (the combination of prediction results for the sub-image block a can be used as the prediction results for the image block A) and the image block A; or, the processing device compares the difference and/or costs between the prediction results for the sub-image block a corresponding to each of the at least one motion candidate offset and the sub-image block a. Optionally, the processing device may select a candidate offset (i.e., the first motion offset information) for predicting the unit to be processed based on the motion candidate offset (i.e., the second motion offset information) corresponding to the motion vector colsbmv having the smallest difference and/or cost. For example, if the second motion offset information is the motion vector of the left neighboring area of image block A, then the first motion offset information is the motion vector of the left neighboring area of the unit to be processed. If the second motion offset information is the motion vector of the upper neighboring area of image block A, then the first motion offset information is the motion vector of the upper neighboring area of the unit to be processed.

Optionally, during subsequent prediction processing of the unit to be processed, the processing device may directly use, in at least one first area of the unit to be processed, a motion vector sampled from the center of the first area corresponding to the selected candidate offset as the first motion offset information of the unit to be processed in order to determine the first motion offset information of the unit to be processed. Prediction processing is then performed on the unit to be processed after determining the first motion offset information.

Optionally, referring to FIG. 11, assuming that image block A includes four sub-image blocks: sub-image block sbCU0, sub-image block sbCU1, sub-image block sbCU2, and sub-image block sbCU3. In this case, the processing device selects four neighboring areas (neighboring area R1, neighboring area R2, neighboring area R3, and neighboring area R4) surrounding image block A as the first area. Optionally, the four neighboring areas selected around image block A can also be considered adjacent areas of sub-image block a. Optionally, the processing device can select non-neighboring but adjacent areas as the first area. Then, if the motion vectors corresponding to the center samples of the four neighboring areas all exist and point to collocated picture 1 or collocated picture 2 rather than to other reference images, the processing device can determine that the four neighboring areas are available. In this case, the processing device can use the four motion vectors corresponding to these four neighboring areas as candidate offset 1, candidate offset 2, candidate offset 3, and candidate offset 4. The processing device then determines collocated picture blocks A1′-A4′ with respect to image block A in collocated picture 1 or collocated picture 2 based on these four candidate offsets.

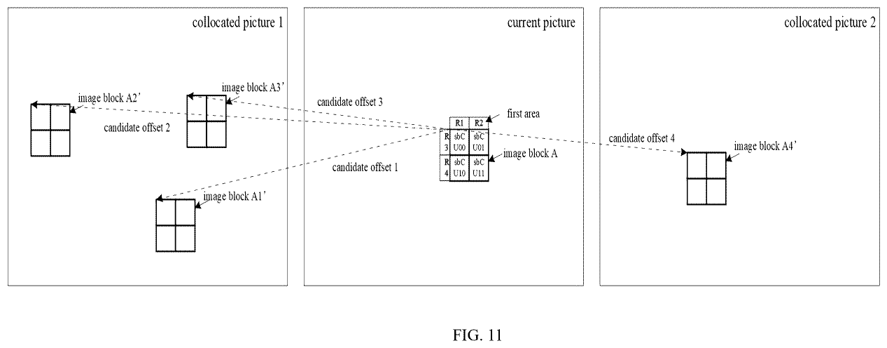

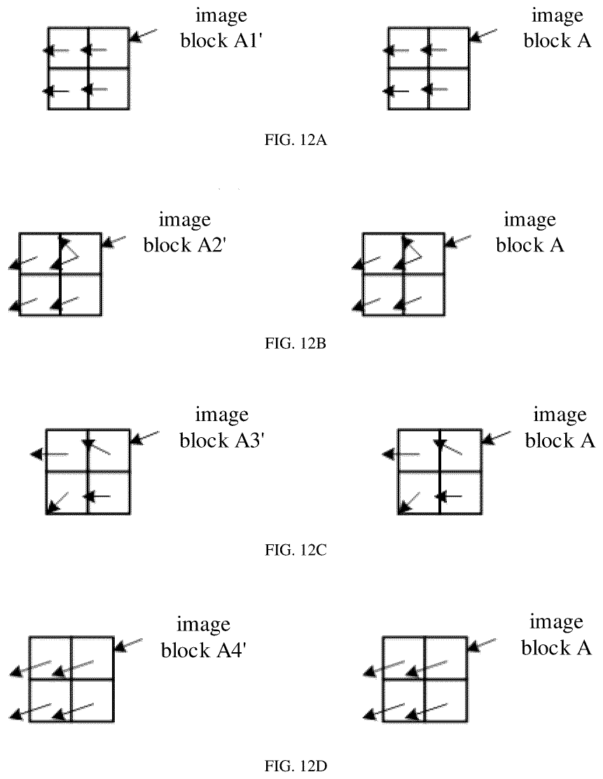

Optionally, as shown in FIG. 12A, after the processing device determines the collocated picture blocks A1′˜A4′ with respect to the image block A, if the motion vectors corresponding to the sub-blocks in the image block A1′ determined by the candidate offset 1 are all unidirectionally predicted, and/or the prediction direction of each motion vector is all to the left, then the processing device can determine the motion vectors of the sub-image blocks with the same position in the image block A through the motion vector corresponding to each sub-block in the image block A1′.

Optionally, as shown in FIG. 12A, the processing device can use the motion vector of the sub-image block a at the upper left corner of the image block A1′ in the collocated picture to determine the motion vector of the sub-image block at the upper left corner of the image block A in the current picture; and use the motion vector of the sub-image block a at the upper right corner of the image block A1′ in the collocated picture to determine the motion vector of the sub-image block at the upper right corner of the image block A in the current picture; use the motion vector of the sub-image block a at the lower left corner of the image block A1′ in the collocated picture to determine the motion vector of the sub-image block at the lower left corner of the image block A in the current picture; and/or use the motion vector of the sub-image block a at the lower right corner of the image block A1′ in the collocated picture to determine the motion vector of the sub-image block at the lower right corner of the image block A in the current picture.

Optionally, as shown in FIG. 12B, if the motion vectors corresponding to the sub-blocks in image block A2′ determined by the candidate offset 2 exist three unidirectionally predicted motion vectors and one bidirectionally predicted motion vector, then the motion vector corresponding to each sub-block in the image block A2′ can be processed to determine the motion vector of the sub-image block with the same position in the image block A.

Optionally, as shown in FIG. 12C, if the motion vectors corresponding to the sub-blocks in image block A3′ determined by candidate offset 3 have four unidirectionally predicted motion vectors, and two of these motion vectors have the same direction, the processing device interface can determine the motion vectors of the sub-blocks in the same position in image block A using the motion vector corresponding to each sub-block in image block A3′.

Optionally, as shown in FIG. 12D, if the motion vectors corresponding to the sub-blocks in image block A4′ determined by candidate offset 4 have four unidirectionally predicted motion vectors, and/or these four motion vectors have the same direction, the processing device can determine the motion vectors of the sub-blocks in the same position in image block A using the motion vector corresponding to each sub-block in image block A4′.

Optionally, the processing device uses each sub-block motion vector of image block A shown in FIGS. 12A to 12D to perform inter-frame prediction on image block A to obtain a prediction result corresponding to image block A, and determines the optimal candidate offset among candidate offsets 1 to candidate offsets 4 based on a comparison result of the prediction result and image block A, thereby selecting the optimal candidate offset as the candidate offset for prediction processing of the current unit to be processed.

Optionally, when determining at least one collocated sub-image block for the at least one candidate offset, the processing device does not need to determine the position of the collocated picture block.

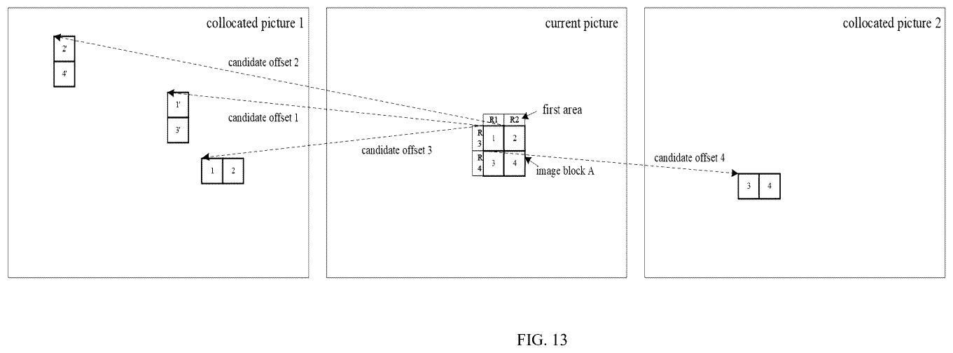

Optionally, as shown in FIG. 13, if a candidate offset MV11 is (xmv, ymv) and/or the position of the sub-processing unit of the unit to be processed in the current picture is (x0, y0), the processing device may directly determine the position of the collocated sub-processing unit of the sub-processing unit as (x0+xmy, y0+ymv).

In this embodiment, since the processing device can directly determine the position of the collocated sub-processing unit within the unit to be processed without determining the position of the collocated picture block, the processing device can effectively conserve its own computing power, thereby improving computational efficiency throughout the image encoding and decoding process.

Optionally, as shown in FIG. 13, the processing device may utilize the first area above image block A to determine the collocated sub-image block of the sub-image block located in the vertical direction of the first area above image block A; or, the processing device may utilize the first area to the left of image block A to determine the collocated sub-image block of the sub-image block located in the horizontal direction of the first area to the left.

In this embodiment, the processing device determines the collocated sub-processing unit of the sub-processing unit in the unit to be processed by the above-mentioned method of determining the collocated sub-image block of the sub-image block, which can effectively improve the accuracy of determining the motion vector or the motion vector candidate of the sub-processing unit.

Optionally, as shown in FIG. 13, since sub-image blocks 1 and 3 of image block A are located below first area R1, collocated sub-image blocks 1′ and 3′ are determined based on candidate offset 1 determined for first area R1. Furthermore, since sub-image blocks 2 and 4 of image block A are located below first area R2, collocated sub-image blocks 2′ and 4′ are determined based on candidate offset 2 determined for first area R2. Since sub-image blocks 1 and 2 of image block A are located to the right of first area R3, collocated sub-image blocks 1 and 2 are determined based on candidate offset 3 determined for first area R3. Optionally, since sub-image blocks 3 and 3 of image block A are located to the right of first area R4, collocated sub-image blocks 3 and 4 are determined based on candidate offset 4 determined for first area R4.

Optionally, the processing device may obtain motion information of the sub-processing unit within the unit to be processed based on the combination of at least one candidate offset, and determine the prediction result for the unit to be processed based on the motion information.

Optionally, the processing device may select a corresponding candidate offset for each sub-image block from the at least one candidate offset based on the positional relationship between the first area corresponding to the at least one candidate offset and each sub-image block, and combine the corresponding candidate offsets to obtain at least one candidate offset combination.

Optionally, as shown in FIG. 14A, the processing device may combine candidate offset 3 and candidate offset 4, and use the motion vectors of collocated sub-image blocks 1-4 corresponding to candidate offsets 3 and 4 as the motion vectors of sub-image blocks 1-4 in image block A.

Optionally, candidate offsets 3 and 4 are both candidate offsets obtained from the first area to the left of image block A.

Optionally, as shown in FIG. 14A, the processing device may further combine candidate offsets 1 and 2, and use the motion vectors of the collocated sub-image blocks 1-4′ corresponding to candidate offsets 1 and 2 as the motion vectors of sub-image blocks 1-4 in image block A.

Optionally, candidate offsets 1 and 2 are both candidate offsets obtained from the first area above the image block.

Optionally, after determining the motion vectors of sub-image blocks 1-4 in image block A, the processing device may use the motion vectors of each sub-block of image block A shown in FIG. 14A to perform inter-frame prediction on the sub-image blocks in image block A to obtain prediction results 1-4 corresponding to sub-image blocks 1-4. And/or, the processing device may combine prediction results 1-4 and compare them with image block A to obtain comparison result 1.

Optionally, the processing device may also use the motion vector of each sub-block of image block A shown in FIG. 14B to perform inter-frame prediction on the sub-image blocks in image block A to obtain prediction results 1′-4′ corresponding to sub-image blocks 1-4, and then combine the prediction results 1′-4′ to obtain a synthesized prediction result, and compare the synthesized prediction result with image block A to obtain comparison result 2.

Optionally, after obtaining the aforementioned comparison results 1 and 2, the processing device may determine, based on the aforementioned comparison results 1 and 2, whether to select candidate offsets 3 and 4, or candidate offsets 1 and 2, as the optimal candidate offsets.

Optionally, the processing device may perform the aforementioned comparison by calculating the absolute difference and the SAD or SATD between the synthesized prediction result and image block A.

Optionally, the processing device may also select at least one candidate offset from the at least one candidate offset and, collectively determine candidate offsets for all sub-image blocks within an image block based on a combination of the selected at least one candidate offset.

Optionally, the candidate offsets selected by the processing device are used to determine candidate offsets for a predetermined position, predetermined direction (e.g., horizontal or vertical), predetermined range, and predetermined number of sub-image blocks within the image block.

Optionally, the process of selecting at least one candidate offset by the processing device includes:

combining at least one composite image block (e.g., image block A1′ in FIG. 14A and image block A2′ in FIG. 14B) based on the collocated sub-image blocks corresponding to the at least one candidate offset, and determining the at least one selected candidate offset and its combination based on a comparison of prediction results corresponding to the at least one composite image block.

Optionally, the image block corresponding to the at least one candidate offset selected in the combination is within a preset range. Optionally, when the size of the image block is greater than a threshold, the at least one candidate offset selected in the combination is used to determine the motion vector of the sub-processing unit of the unit to be processed. When the size of the image block is less than the threshold, only one candidate offset selected from the at least one candidate offset is used to determine the motion vector of the sub-processing unit of the unit to be processed.

Optionally, when the size of the image block is less than the threshold, only the preset candidate offset may be used to determine the motion vector of the sub-processing unit of the unit to be processed.

In this embodiment, by selecting candidate offsets based on the size of the image block to determine the motion vector for the sub-processing unit, a good balance between computing power and performance is achieved.

Optionally, when determining the second motion offset information for the first image unit, the processing device may determine the second motion offset information based on the matching cost corresponding to at least one first sample in the first image unit. Specifically, the motion information of the first sample corresponding to the minimum matching cost among the matching costs corresponding to the at least one first sample is determined as the second motion offset information for the first image unit.

Optionally, assuming that the first image unit is image block A, image block A is an image block in the current picture that has been encoded or decoded, and/or image block A is adjacent to or proximate to a unit to be processed that currently needs to be encoded or decoded. Optionally, image block A is also referred to as a template image block.

Optionally, the processing device uses the image block A to test the most appropriate motion offset information (or candidate motion offset), and then adopts the candidate offset corresponding to the image block A for the unit to be processed. In this way, the processing device determines appropriate motion offset information from at least one piece of motion offset information of the image block A, then selects an appropriate sample from the adjacent samples and neighboring samples corresponding to the unit to be processed, and uses the motion information corresponding to the appropriate sample as the motion offset information of the unit to be processed. Prediction processing is then performed on the sub-processing unit in the unit to be processed, thereby improving image block prediction accuracy and/or video coding efficiency.

Optionally, the processing device may further determine appropriate motion offset information from the at least one piece of motion offset information, and then select motion offset information of the same type as the appropriate motion offset information from the at least one piece of motion offset information corresponding to the unit to be processed.

Optionally, assuming that image block A includes motion offset information X, motion offset information Y, and motion offset information Z. Motion offset information X corresponds to a motion vector sampled at the center of a first sample X, motion offset information Y corresponds to a motion vector sampled at the center of a first sample Y, and motion offset information Z corresponds to a motion vector sampled at the center of a first sample Z. In this manner, if the motion offset information X is determined to be the motion offset information with the lowest derived matching cost from the three pieces of motion offset information for image block A, the processing device may use the motion offset information X′ corresponding to the first sample X′ of the unit to be processed as the selected motion offset information when performing prediction processing on the unit to be processed. Optionally, the positional relationship between the first sample X and image block Ais the same as or similar to the positional relationship between the first sample X′ and the unit to be processed.

Optionally, if the first sample X is located above image block A, then the first sample X′ is located above the unit to be processed.

Optionally, if the first sample X is located above the left of image block A, then the first sample X′ is located above the left of the unit to be processed.

Optionally, if the first sample X is located above image block A, then the first sample X′ is located above the unit to be processed.

Optionally, if the first sample X is not adjacent to image block A, then the first sample X′ is not adjacent to the unit to be processed.

Optionally, when performing predictive processing on the unit to be processed based on the above process, the processing device first sets the reference image with the smallest image sequence distance to the current picture as the collocated picture of the current picture. The processing device then determines an image block A in the current picture for deriving motion offset information. The image block A is located in an already coded area of the current picture and not in the current coding unit, and/or the size of image block A is the same as the size of the unit to be processed. The processing device then sets at least one first sample around image block A. Optionally, the at least one first sample is an adjacent sample or a neighboring sample. The processing device then determines at least one candidate motion offset based on the at least one first sample. Optionally, the processing device determines the at least one first sample and a motion vector used by the at least one first sample, and when these motion vectors point to a collocated picture, uses these motion vectors as the at least one candidate motion offset.

After determining at least one motion candidate offset, the processing device determines, for each of the at least one motion candidate offset, at least one collocated picture block A′ of image block A in the collocated picture, or determines a collocated sub-image block a′ of the at least one collocated picture A′ based on the position of image block A/sub-image block a. Optionally, sub-image block a is a sub-image block of image block A, that is, image block A includes sub-image block a. Optionally, sub-image block a is a sub-CU, and/or sub-image block a is also located in a coded area of the current picture and not in the current coding unit.

The processing device determines at least one collocated picture block A′ of image block A in the collocated picture, or after determining the collocated sub-image block a′ of the at least one collocated picture A′, determines at least one motion vector mva of at least one sub-image block a in image block A using each of the at least one motion vector colsbmv of the at least one collocated sub-image block a′. Furthermore, the processing device uses the at least one motion vector mva to perform inter-frame prediction on the at least one sub-image block a in image block A to obtain a corresponding prediction result. Finally, the processing device compares the difference (e.g., SAD, SATD values representing matching cost) and/or cost (e.g., rate-distortion cost) between the combination of prediction results for the sub-image block (the combination of prediction results for sub-image block a can be used as the prediction result for image block A) corresponding to each of the at least one motion candidate offsets and image block A, or compares the difference and/or cost between the prediction results for sub-image block a corresponding to each of the at least one motion candidate offsets and sub-image block A. Optionally, the processing device may select the motion candidate offset corresponding to the motion vector colsbmv having the smallest difference and/or cost as the candidate offset selected for prediction processing of the unit to be processed.

Optionally, in the subsequent process of predictive processing of the unit to be processed, in order to determine the first motion offset information of the unit to be processed, the processing device may directly use the first sampled motion vector corresponding to the above-selected candidate offset in at least one first area of the unit to be processed as the first motion offset information of the unit to be processed, and perform predictive processing on the unit to be processed after determining the first motion offset information.

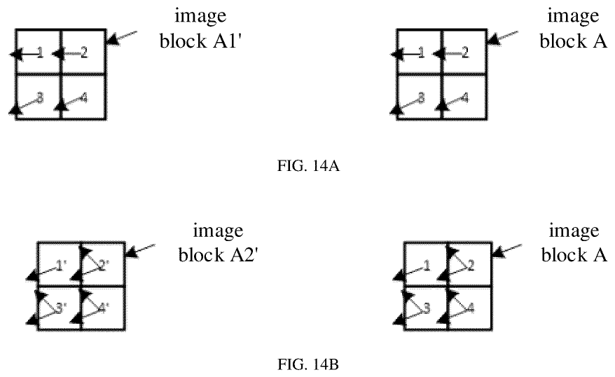

Optionally, referring to FIG. 15, assuming that image block A includes four sub-image blocks: sub-image block sbCU0, sub-image block sbCU1, sub-image block sbCU2, and sub-image block sbCU3. In this case, the processing device selects four neighboring samples (neighboring sample n0, neighboring sample B1, neighboring sample A0, and neighboring sample A1) around image block A as the first sample. Optionally, the four neighboring samples selected around image block A can also be considered as adjacent samples of sub-image block a. Optionally, the processing device can select non-neighboring but adjacent samples as the first sample.

Optionally, if the motion vectors corresponding to the four neighboring samples all exist and point to the collocated picture 1 or the collocated picture 2 but not to other reference images, then these four neighboring samples are all available. If the motion vectors corresponding to one or more of the four neighboring samples do not exist, or the motion vectors corresponding to one or more of the four neighboring samples do not point to the collocated picture 1 or the collocated picture 2 but to other reference images, then these neighboring samples are not available.

Optionally, when all four neighboring samples are available, the processing device uses four motion vectors corresponding to the four neighboring samples as candidate offset 1, candidate offset 2, candidate offset 3, and candidate offset 4. Then, the processing device determines, in the collocated picture 1 or the collocated picture 2, collocated picture blocks with respect to the image block A—image block A0, image block A1, image block B0, and image block B1—for the four candidate offsets.

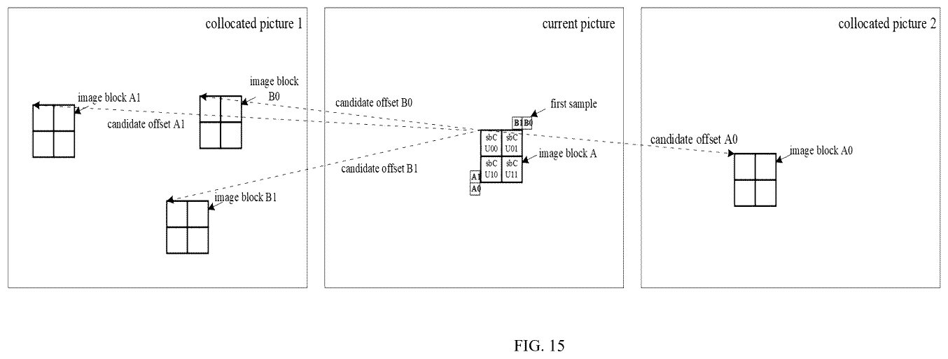

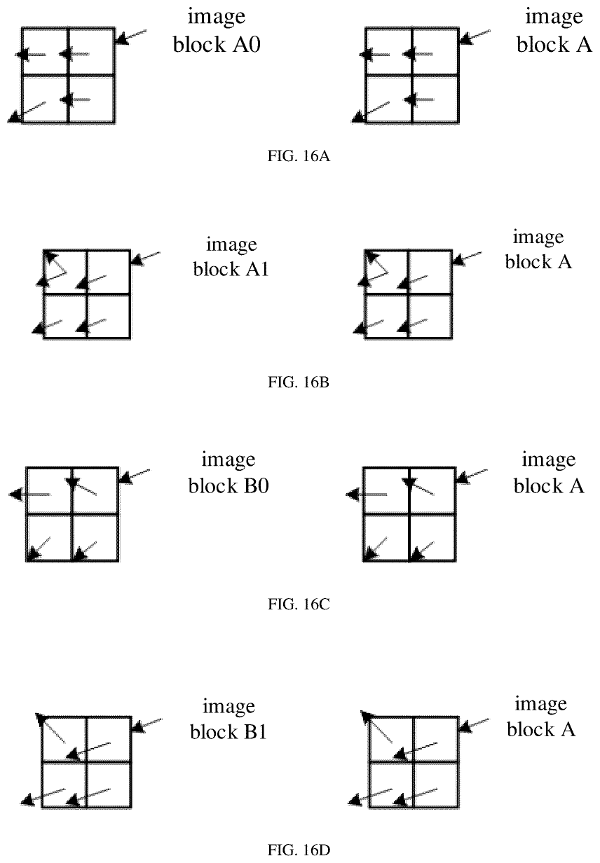

Optionally, as shown in FIG. 16A, if the motion vectors corresponding to each sub-block in image block A0 determined by candidate offset A0 are all unidirectionally predicted, the processing device determines the motion vectors of the sub-blocks in the same position in image block A using the motion vectors corresponding to each sub-block in image block A0.

Optionally, as shown in FIG. 16B, if the motion vectors corresponding to the sub-blocks in image block A1 determined by candidate offset A1 include three unidirectionally predicted motion vectors and one bidirectionally predicted motion vector, the processing device determines the motion vectors of the sub-blocks in the same position in image block A using the motion vectors corresponding to each sub-block in image block A1.

Optionally, as shown in FIG. 16C, if four unidirectionally predicted motion vectors exist for the motion vectors corresponding to the sub-blocks in image block B0 determined by candidate offset n0, the processing device determines the motion vectors of the sub-blocks in the same position in image block A using the motion vectors corresponding to each sub-block in image block B0.

Optionally, as shown in FIG. 16D, if four unidirectionally predicted motion vectors exist for the motion vectors corresponding to the sub-blocks in image block B1 determined by candidate offset B1, the processing device determines the motion vectors of the sub-blocks in the same position in image block A using the motion vectors corresponding to each sub-block in image block B1.

Optionally, after determining the motion vector of the processed sub-image block, the processing device similarly uses the motion vector of each sub-block of image block A shown in FIGS. 12a to 12d to perform inter-frame prediction on image block A to obtain a prediction result corresponding to image block A. The processing device then compares the obtained prediction result with image block A to obtain a comparison result, and based on the comparison result, determines the optimal candidate offset among the candidate offsets A0-A1 and the candidate offsets B0-B1, and selects the optimal candidate offset as the selected candidate offset.

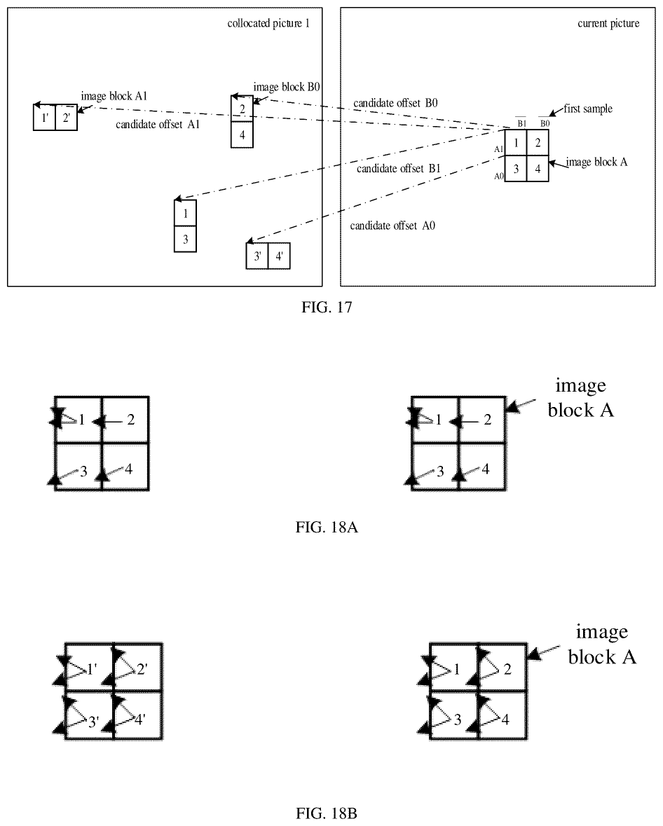

Optionally, as shown in FIG. 17, the processing device can use the first sample above image block A to determine the collocated sub-image block vertically adjacent to the first sample above it; or it can use the first sample to the left of image block A to determine the collocated sub-image block horizontally adjacent to the first sample.

In this embodiment, the processing device uses the aforementioned method of determining collocated sub-image blocks of sub-image blocks to determine the collocated sub-processing units of the unit to be processed, effectively improving the accuracy of determining motion vectors or motion vector candidates for the sub-processing units.

Optionally, as shown in FIG. 17, since sub-image blocks 1 and 3 of image block A are located below first sample B1, the processing device may determine collocated sub-image blocks 1 and 3 based on candidate offset B1 determined by first sample B1. Furthermore, since sub-image blocks 2 and 4 of image block A are located below first sample B2, the processing device may determine collocated sub-image blocks 2 and 4 based on candidate offset B2 determined by first sample B2. Since sub-image blocks 1 and 2 of image block A are located to the right of first sample A1, the processing device can determine collocated sub-image blocks 1′ and 2′ based on candidate offset A1 determined for first sample A1. Optionally, because sub-image blocks 3 and 3 of image block A are located to the right of first sample A2, the processing device can determine collocated sub-image blocks 3′ and 4′ based on candidate offset A2 determined for first sample A2.

Optionally, the processing device may further use the motion vector of the collocated sub-processing unit corresponding to each of the at least one candidate offset as the motion information of at least one of the units to be processed, and determine the prediction result for the unit to be processed based on the motion information.

Optionally, as shown in FIG. 18A, the processing device may use the motion vectors of the collocated sub-image blocks 1-4′ corresponding to the candidate offsets A0 and A1 as the motion vectors of sub-image blocks 1-4 in image block A. Optionally, the processing device may also use the motion vectors of the collocated sub-image blocks 1-4 corresponding to the candidate offsets B0 and B1 as the motion vectors of sub-image blocks 1-4 in image block A.

Optionally, after determining the motion vectors of sub-image blocks 1-4 in image block A, the processing device may use the motion vectors of each sub-block of image block A shown in FIG. 18a to perform inter-frame prediction on the sub-image blocks in image block A, thereby obtaining prediction results 1-4′ corresponding to sub-image blocks 1-4. The processing device then combines the prediction results 1-4′ and compares them with image block A to obtain comparison result 11.

Optionally, the processing device uses the motion vector of each sub-block of image block A shown in FIG. 18B to perform inter-frame prediction on the sub-image blocks in image block A, and obtains prediction results 1-4 corresponding to sub-image blocks 1-4. And/or, the processing device combines prediction results 1-4 to obtain a synthesized prediction result, and compares the synthesized prediction result with image block A to obtain comparison result 12.

Optionally, after obtaining the comparison results 11 and 12, the processing device can determine whether to select candidate offsets A0 and A1, or candidate offsets B0 and B1, as the optimal candidate offsets based on the comparison results 11 and 13.

Optionally, the processing device can perform the comparison by calculating the absolute difference and the SAD or SATD between the synthesized prediction result and image block A.

Optionally, when determining the second motion offset information of the above-mentioned first image unit, the processing device may also determine the second motion offset information based on the matching cost corresponding to at least one second area of the sub-image unit in the first image unit, that is, the motion information of the second area corresponding to the minimum matching cost among the matching costs corresponding to at least one second area is determined as the second motion offset information of the first image unit.

Optionally, assuming that the sub-image unit in the above-mentioned first image unit is sub-image block a, the processing device determines appropriate motion offset information from at least one motion offset information of the sub-image block a, and then selects a suitable area from the adjacent areas and neighboring areas corresponding to the sub-processing units in the unit to be processed so that the motion information corresponding to the sampling of the suitable area is used as the second motion offset information of the unit to be processed to perform prediction processing on the sub-processing units in the unit to be processed, thereby improving the prediction accuracy and/or efficiency of video encoding.

Optionally, the processing device determines appropriate motion offset information from at least one motion offset information, and then selects motion offset information of the same type as the above-mentioned appropriate motion offset information from at least one motion offset information corresponding to the sub-processing unit of the unit to be processed, thereby improving the prediction accuracy and/or efficiency of video encoding.

Optionally, assuming that sub-image block a includes motion offset information X, motion offset information Y, and motion offset information Z, where motion offset information X corresponds to a motion vector sampled at the center of second area X, motion offset information Y corresponds to a motion vector sampled at the center of second area Y, and motion offset information Z corresponds to a motion vector sampled at the center of second area Z. In this manner, if the processing device determines, from among the several pieces of motion offset information for sub-image block a, that motion offset information X is the motion offset information derived with the lowest matching cost, then, when performing prediction processing on a unit to be processed, the processing device may use motion offset information X′ corresponding to the sampled at the center of second area X′ corresponding to the unit to be processed as the motion offset information selected for predicting the unit to be processed. For example, if the motion offset information X determined from at least one piece of motion offset information for sub-image block a is the motion vector of the left adjacent area of sub-image block a, then the motion offset information X′ corresponding to the center sample of the corresponding second area X′ of the unit to be processed is the motion vector corresponding to the center sample of the left adjacent area of the unit to be processed. If the motion offset information X determined from at least one piece of motion offset information for sub-image block a is the motion vector of the upper adjacent area of sub-image block a, then the motion offset information X′ corresponding to the center sample of the corresponding second area X′ of the unit to be processed is the motion vector of the upper adjacent area of the unit to be processed.

Optionally, the sub-image block a is a processed sub-image block in the current picture, and/or is located adjacent to or proximate to the unit to be processed.

Optionally, when performing predictive processing on the unit to be processed based on the above process, the processing device first sets the reference image with the smallest image sequence distance to the current picture as the collocated picture of the current picture. The processing device then determines the sub-image block a in the current picture for deriving motion offset information.

Optionally, the sub-image block a is located in a processed area of the current picture and not in the unit to be processed, and/or the size of the sub-image block a is the same as the size of the sub-processing unit in the unit to be processed.

Optionally, the processing device may determine a sub-image block a in the current picture for deriving motion offset information. Optionally, the processing device may also determine at least one sub-image block a in the current picture for deriving motion offset information.

Optionally, when the processing device functions as an encoding device, the processed area is an encoded area, and when the processing device functions as a decoding device, the processed area is a decoded area.

Optionally, after determining sub-image block a in the current picture, the processing device may set at least one second area around the one or more sub-image blocks a. Optionally, the at least one second area is an adjacent or neighboring area of sub-image block a. The processing device then determines at least one first candidate offset from the at least one second area.

Optionally, the processing device may determine the center samples of at least one second area and the motion vectors used for these center samples. If these motion vectors point to the collocated picture, these motion vectors may be used as at least one candidate offset.

Optionally, after determining at least one candidate offset, the processing device determines, for each of the at least one candidate offset, at least one collocated sub-image block a′ in the collocated picture based on the position of sub-image block a. Then, based on each of the at least one motion vectors colsbmv′ for the at least one collocated sub-image block a′, at least one motion vector mva′ for sub-image block a is determined. And/or, the processing device performs inter-frame prediction on sub-image block a through using the at least one motion vector mva′ to obtain a prediction result. The processing device then compares the prediction result for sub-image block a corresponding to each of the at least one candidate offset with the difference (e.g., SAD or SATD value representing the matching cost) and/or the cost (e.g., rate-distortion cost) between the prediction result for sub-image block a and sub-image block a. The candidate offset type corresponding to the motion vector colsbmv′ with the smallest difference and/or cost is selected as the candidate offset type.

Optionally, after selecting the candidate offset type with the lowest matching cost from at least one candidate offset, the processing device may determine a candidate offset for a subsequent unit to be processed based on the selected candidate offset type, for use in prediction processing of the unit to be processed.

Optionally, the candidate offset selected by the processing device may be used for prediction processing of each sub-unit within the unit to be processed.

Optionally, if the candidate offset selected by the processing device is the motion offset information x corresponding to the second area x, then the candidate offset for the unit to be processed may be the motion information of a second area x′ of the unit to be processed that corresponds to the second area x.

Optionally, if the second area x is above sub-image block a, then the second area x′ corresponding to the second area x is the above area of the unit to be processed.

Optionally, if the second area x is to the left of sub-image block a, then the second area x′ corresponding to the second area x is the left of the unit to be processed.

Optionally, the second area x′ corresponds to the position of the second area x.

Optionally, if the prediction result obtained in the above process is the best result compared to prediction results obtained by other prediction methods, the processing device at the encoding end sends at least one flag in the bitstream to instruct the processing device at the decoding end to also perform prediction processing using the above process.

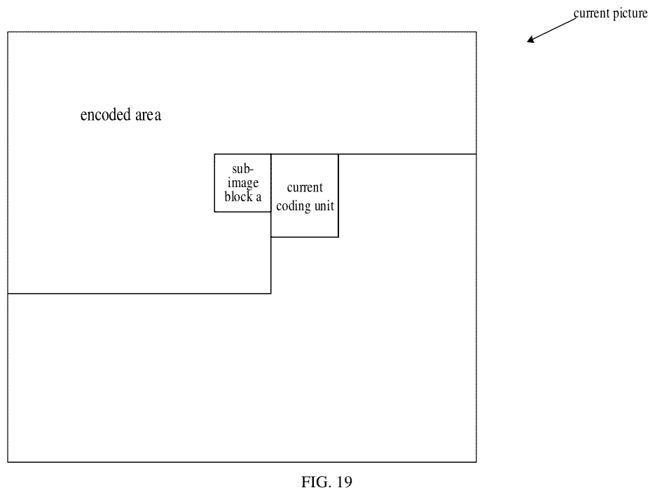

Optionally, as shown in FIG. 19, the processing device selects, within the processed area of the current picture, an adjacent/neighboring area of the same size as the sub-processing unit in the unit to be processed as sub-image block a.

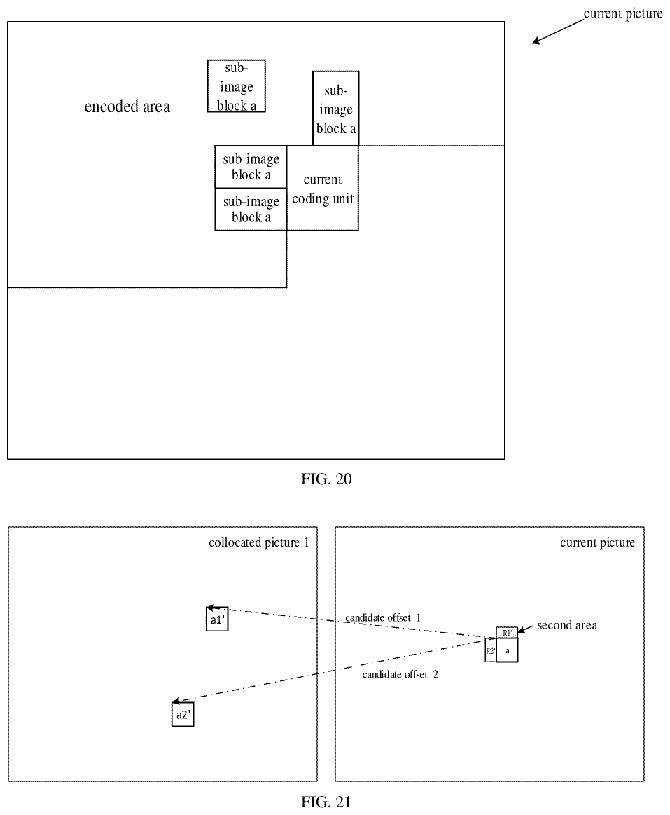

Optionally, as shown in FIG. 20, the processing device may also select, within the processed area of the current picture, at least one adjacent/neighboring area of the same size as the sub-processing unit in the unit to be processed as at least one sub-image block a.

Optionally, the at least one sub-image block a includes: a sub-image block adjacent to the unit to be processed and a sub-image block not adjacent to the unit to be processed.

Optionally, the sub-image block a not adjacent to the unit to be processed is an image block that is not adjacent to the unit to be processed but is adjacent to it.

In this embodiment, when a sub-image block adjacent to the unit to be processed is unavailable, the processing device may select a block adjacent to but not adjacent to the unit to be processed.

Optionally, the sub-image block a is a sub-image block not adjacent to the unit to be processed but whose image content is similar to that of a sub-processing unit within the unit to be processed.

Optionally, the sub-image block a is: a sub-image block a obtained by intra-block copying the unit to be processed. That is, in this embodiment, the processing device can determine the candidate offset of the current coding unit according to the sub-image block a obtained by intra-block copying.

Optionally, as shown in FIG. 21, the processing device may also select two neighboring areas (neighboring area R1′ and neighboring area R2′) around sub-image block a as the second area. If motion vectors corresponding to the center samples of both neighboring areas exist and point to collocated picture 1 or collocated picture 2 rather than other reference images, the processing device can determine that both neighboring areas are available. In this manner, the processing device uses the two motion vectors corresponding to these two neighboring areas as candidate offset 1 and candidate offset 2. The processing device then determines, in collocated picture 1 or collocated picture 2, collocated sub-image blocks a1′ to a2′ with respect to sub-image block a based on these two candidate offsets.

Optionally, the processing device may select a non-neighboring but adjacent area as the second area.

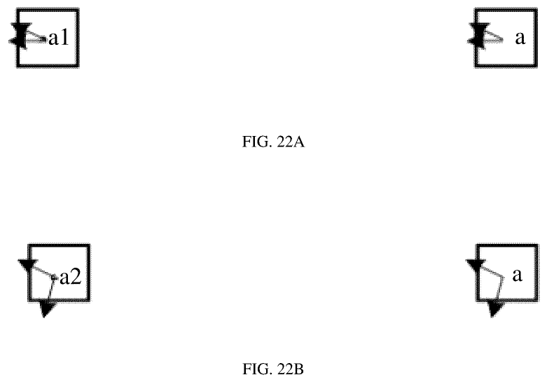

Optionally, as shown in FIG. 22A, the processing device uses the motion vector of the collocated sub-image block a1′ corresponding to candidate offset 1 as the motion vector of sub-image block a. As shown in FIG. 22B, the processing device uses the motion vector of the collocated sub-image block a2′ corresponding to candidate offset 2 as the motion vector of sub-image block a. Afterwards, the processing device uses the sub-block motion vector of the sub-image block a shown in FIG. 22A to perform inter-frame prediction on the sub-image block a to obtain the prediction result a1 corresponding to the sub-image block a, and compares the prediction result a1 with the sub-image block a to obtain the comparison result a1. Similarly, using the sub-block motion vector of sub-image block a shown in FIG. 22B, inter-frame prediction is performed on sub-image block a to obtain prediction result a2 corresponding to sub-image block a. Prediction result a2 is then compared with sub-image block a to obtain comparison result a2. Finally, the processing device determines whether to select candidate offset 1 or candidate offset 2 as the optimal candidate offset based on comparison results a1 and a2.

Optionally, the processing device may perform the comparison by calculating the absolute difference (SAD) or SATD between the synthesized prediction result and image block A.

Optionally, when determining the second motion offset information for the first image unit, the processing device may further determine the second motion offset information based on a matching cost derived from at least one second sample of the sub-image block. Specifically, the motion information of the first sample corresponding to the minimum matching cost among the matching costs corresponding to the at least one first sample is determined as the second motion offset information for the first image unit.

Optionally, the processing device determines appropriate motion offset information from at least one motion offset information of image block A, and then selects a suitable sample from the adjacent samples and neighboring samples corresponding to the sub-processing unit of the unit to be processed, so that the motion offset information corresponding to the suitable sample is used as the motion offset information of the unit to be processed to perform prediction processing on the sub-processing unit in the unit to be processed, thereby improving the prediction accuracy and/or efficiency of video encoding.

Optionally, the processing device determines appropriate motion offset information from at least one motion offset information, and then selects motion offset information of the same type as the above-mentioned appropriate motion offset information from at least one motion offset information corresponding to the unit to be processed, thereby improving the prediction accuracy and/or efficiency of video encoding.

Optionally, assuming that image block A includes motion offset information X, motion offset information Y, and motion offset information Z, where motion offset information X corresponds to the motion vector of the second sample X, motion offset information Y corresponds to the motion vector of the second sample Y, and motion offset information Z corresponds to the motion vector of the second sample Z. If the processing device determines, from among the several pieces of motion offset information for image block A, that motion offset information X is the motion offset information with the lowest derived matching cost, then when performing prediction processing on the unit to be processed, the processing device may select motion offset information X corresponding to the second sample X of the unit to be processed as the selected motion offset information.

Optionally, the image block A is a processed image block in the current picture, and/or the image block A is adjacent to or proximate to the current unit to be processed.

Optionally, when performing predictive processing on the unit to be processed based on the above process, the processing device first sets the reference image with the smallest image sequence distance to the current picture as the collocated picture of the current picture. The processing device then determines a sub-image block a in the current picture for deriving motion offset information and sets at least one second sample (at least one of the second samples is an adjacent or proximate sample) around one or more sub-image blocks a, thereby determining at least one first candidate offset from the at least one second sample.

Optionally, the processing device determines at least one second sample and the motion vectors used by these samples. If these motion vectors point to the collocated picture, these motion vectors are used as at least one first candidate offset.

Optionally, after determining the at least one candidate offset, the processing device determines, for each of the at least one candidate offset, at least one collocated sub-image block a′ in the collocated picture based on the position of sub-image block a. Then, using each of the at least one motion vectors colsbmv′ for the at least one collocated sub-image block a′, at least one motion vector mva′ for sub-image block a is determined. And/or, using the at least one motion vector mva′, inter-frame prediction is performed on sub-image block a to obtain a prediction result. Thereafter, the processing device compares the difference (e.g., a SAD or SATD value representing a matching cost) and/or cost (e.g., a rate-distortion cost) between the prediction result for sub-image block a corresponding to each of the at least one candidate offsets and sub-image block a. The candidate offset type corresponding to the motion vector colsbmv′ with the smallest difference and/or cost is selected as the candidate offset type.

Optionally, after selecting the candidate offset type with the lowest matching cost from at least one candidate offset, the processing device may determine a candidate offset for a subsequent unit to be processed based on the selected candidate offset type, for use in prediction processing of the unit to be processed.

Optionally, the candidate offset selected by the processing device may be used for prediction processing of each sub-unit within the unit to be processed.

Optionally, if the candidate offset selected by the processing device is motion offset information x corresponding to a second area x, then the candidate offset for the unit to be processed may be motion information of a second area x′ of the unit to be processed that corresponds to the second area x.

Optionally, if the second area x is above sub-image block a, then the second area x′ corresponding to the second area x is the above area of the unit to be processed.

Optionally, if the second area x is to the left of sub-image block a, then the second area x′ corresponding to the second area x is the left of the unit to be processed.

Optionally, the second area x′ corresponds to the position of the second area x.

### Fifth Embodiment

In this embodiment, the image processing method provided herein can still be executed by the aforementioned processing device.

In this embodiment, optionally, the aforementioned first image unit is an image unit of the same size as the unit to be processed; and the first sub-image unit is a sub-image unit of the same size as the sub-processing unit. Optionally, the second motion offset information includes motion information of at least one first area and/or at least one first sample of the first image unit or the first sub-image unit. Optionally, the preset flag includes a first value and/or a second value.

Optionally, when the processing device determines the motion information of the sub-processing unit in the unit to be processed using the motion vector of the collocated sub-processing unit, assuming that the collocated sub-processing unit is sub-image block a and the motion vector corresponding to the sub-image block a is colsbmv1, the processing device can calculate and determine the motion vector mv2 of the sub-processing unit of the unit to be processed in the current picture according to the following formula (1):

$$mv 2 = t 2 * colsbmv 1 / t 1 \qquad Formula ( 1 )$$

Optionally, t1 is the difference in POC between the collocated picture and the reference image, and t2 is the difference in POC between the current picture and the reference image. The current picture is inter-frame predicted using information in the reference image.

Optionally, the processing device may not employ a unidirectional/bidirectional prediction strategy.

Optionally, the processing device determines only the collocated sub-processing unit of the sub-processing unit within the processing unit based on the candidate offset, and then uses the motion vector of the collocated sub-processing unit as the motion vector of the sub-processing unit.

Optionally, if the collocated sub-processing unit block employs unidirectional prediction, the processing device uses only one motion vector as the motion vector of the sub-processing unit in the current picture; and/or, if the collocated sub-processing unit employs bidirectional prediction, the processing device uses both motion vectors as the motion vector of the sub-processing unit in the current picture.

Optionally, when the processing device adopts the unidirectional prediction/bidirectional prediction selection strategy, it may determine whether to adopt the unidirectional prediction or the bidirectional prediction according to strategy information.

Optionally, if the processing device chooses to use unidirectional prediction, then for each collocated sub-processing unit, the processing device selects a motion vector of the collocated sub-processing unit as the motion vector or motion vector candidate for the sub-processing unit in the current picture. In this case, if a collocated processing unit uses bidirectional prediction, the processing device may use the motion vector corresponding to collocated picture 1 as the motion vector/motion vector candidate for the sub-processing unit in the current picture. Optionally, collocated picture 1 is located in reference image list 0.

Optionally, if the processing device chooses to use bidirectional prediction, then for each collocated sub-processing unit, the processing device selects the two motion vectors of the collocated sub-processing unit as the motion vector/motion vector candidate of the sub-processing unit of the current picture. In this case, if a collocated sub-processing unit uses unidirectional prediction, the processing device may use the motion vector corresponding to the unidirectional prediction as one motion vector/motion vector candidate of the sub-processing unit of the current picture, and set the other motion vector/motion vector candidate of the sub-processing unit of the current picture to a zero vector.

Optionally, the aforementioned strategy information may be indicated by a flag.

Optionally, the aforementioned strategy information may also be determined based on the prediction method used by the central sub-block of image block A. Optionally, if the central sub-block of image block A uses unidirectional prediction, the strategy information indicates that unidirectional prediction is used; if the central sub-block of image block A uses bidirectional prediction, the strategy information indicates that bidirectional prediction is used.

Optionally, the above-mentioned strategy information can also be determined according to the prediction method adopted by the center sample of image block A. Optionally, if the center sample of image block A adopts unidirectional prediction, the strategy information indicates that unidirectional prediction is adopted; if the center sample of image block A adopts bidirectional prediction, the strategy information indicates that bidirectional prediction is adopted.

Optionally, the above-mentioned strategy information may also be determined based on the prediction method adopted by the edge sub-image block of the image block A. Optionally, if the sub-image block adjacent to the first adjacent area/adjacent sample in the image block A adopts unidirectional prediction, the strategy information indicates that unidirectional prediction is adopted; if the sub-image block adjacent to the first adjacent area/adjacent sample in the image block A adopts bidirectional prediction, the strategy information indicates that bidirectional prediction is adopted.

The present application also provides a processing device including a memory and a processor. The memory stores an image processing program. When the image processing program is executed by the processor, the steps of the image processing method described in any of the above-mentioned embodiments are implemented.

The present application also provides a storage medium storing a computer program. When the computer program is executed by the processor, the steps of the image processing method described in any of the above-mentioned embodiments are implemented.

The processing device and storage medium embodiments provided herein may include all the technical features of any of the aforementioned image processing method embodiments. The expanded description and explanations are essentially the same as those in the aforementioned method embodiments and are not further elaborated here.

The present application also provides a computer program product including computer program code. When the computer program code is executed on a computer, it causes the computer to perform the image processing methods described in the various possible embodiments described above.

The present application also provides a chip, including a memory and a processor, the memory is used to store computer programs, and the processor is used to call and run computer programs from the memory, so that a device equipped with the chip executes the image processing methods in various possible implementations as described above.

It can be understood that the above-mentioned scenarios are only examples and do not constitute a limitation on the application scenarios of the technical solutions provided in the embodiments of the present application. The technical solutions of the present application can also be applied to other scenarios. For example, it is known to ordinary technicians in the field that with the evolution of the system architecture and the emergence of new business scenarios, the technical solutions provided in the embodiments of the present application are also applicable to similar technical problems.

The serial numbers of the embodiments of the present application are for description only and do not represent the advantages and disadvantages of the embodiments.

The steps in the method of the embodiment of the present application can be adjusted in order, merged and deleted according to actual needs.

The units in the device of the embodiment of the present application can be merged, divided and deleted according to actual needs.

In the present application, the same or similar terminology, technical solution and/or application scenario description is generally described in detail only when it appears for the first time. When it appears again later, it is generally not repeated for the sake of brevity. When understanding the technical solution and other contents of the present application, for the same or similar terminology, technical solution and/or application scenario description that is not described in detail later, please refer to the previous related detailed description.

In the present application, the descriptions of various embodiments have different focuses. For parts that are not described or denoted in a certain embodiment, please refer to the relevant descriptions of other embodiments.

The various technical features of the technical solution of the present application can be combined arbitrarily. In order to make the description concise, all possible combinations of the various technical features in the above embodiments are not described. However, as long as there is no contradiction in the combination of these technical features, they should be considered to fall within the scope of the present application.

Through the above description of the implementation, those skilled in the art can clearly understand that the above embodiment methods can be implemented by software plus the necessary general hardware platform, or by hardware, but in many cases the former is a better implementation. Based on this understanding, the technical solution of the present application essentially or the part that contributes to the existing technology can be embodied in the form of a software product, and the computer software product is stored in one of the above storage media (such as ROM/RAM, disk, optical disk), including several instructions to cause a terminal device (which can be a mobile phone, a computer, a server, a controlled terminal, or a network device, etc.) to execute the method of each embodiment of the present application.

The above embodiments can be implemented in whole or in part by software, hardware, firmware or any combination thereof. When implemented by software, it can be implemented in whole or in part in the form of a computer program product. The computer program product includes one or more computer instructions. When the computer program instructions are loaded and executed on the computer, the process or function according to the embodiment of the present application is generated in whole or in part. The computer can be a general-purpose computer, a special-purpose computer, a computer network, or other programmable device. The computer instructions can be stored in a computer-readable storage medium, or transmitted from one computer-readable storage medium to another computer-readable storage medium. For example, the computer instructions can be transmitted from one website, computer, server or data center to another website, computer, server or data center by wired (such as coaxial cable, optical fiber, digital subscriber line (DSL)) or wireless (such as infrared, wireless, microwave, etc.) means. The computer-readable storage medium can be any available medium that can be accessed by the computer or a data storage device such as a server or data center that includes one or more available media integrated. The available medium can be a magnetic medium (such as a floppy disk, a storage disk, a tape), an optical medium (such as a DVD), or a semiconductor medium (such as a Solid State Disk (SSD)), etc.

The above are only some embodiments of the present application, and are not intended to limit the scope of the present application. Any equivalent structure or equivalent process transformation made using the contents of the specification and drawings of the present application, or directly or indirectly applied in other related technical fields, shall be similarly included in the scope of the present application.

What is claimed is:

1. An image processing method, comprising:
obtaining or determining motion information of a sub-processing unit within a unit to be processed; and
performing luminance and chrominance prediction on the unit to be processed based on the motion information to determine or obtain a prediction result for the unit to be processed.

2. The method according to claim 1, wherein methods for obtaining or determining the motion information of the sub-processing unit comprise at least one of the following:
a first method: obtaining or determining the motion information based on a collocated processing unit of the unit to be processed;
a second method: obtaining or determining the motion information based on a collocated sub-processing unit of the sub-processing unit;
a third method: obtaining or determining the motion information based on a preset sub-block merge candidate list;
a fourth method: obtaining or determining the motion information based on a preset flag;
a fifth method: obtaining or determining the motion information based on first motion offset information;
a sixth method: obtaining or determining the motion information based on second motion offset information of a first image unit or a first sub-image unit in a processed area of an image to be processed;
a seventh method: obtaining or determining the motion information based on a combination of at least one of the second motion offset information; and
an eighth method: obtaining or determining the motion information based on a motion vector prediction candidate list.

3. The method according to claim 2, wherein the second method comprises:
determining a collocated sub-processing unit based on the third motion offset information and the position information of the sub-processing unit; and
obtaining or determining the motion information of the sub-processing unit based on the position information of the collocated sub-processing unit and/or the motion information of the center sample of the collocated sub-processing unit.

4. The method according to claim 2, wherein the fourth method comprises:
in response to the preset flag being a first value, obtaining or determining the motion information of the sub-processing unit based on the motion information of the collocated sub-processing unit; and/or
in response to the preset flag being a second value, obtaining or determining the motion information of the sub-processing unit based on the motion information of a center sample of the collocated processing unit of the unit to be processed.

5. The method according to claim 2, wherein the fifth method comprises:
obtaining or determining first motion offset information based on at least one corresponding first motion information of at least one adjacent area, at least one neighboring area, at least one adjacent sample, or at least one neighboring sample, or obtaining or determining first motion offset information based on a motion offset information list; and
obtaining or determining the motion information of the sub-processing unit based on the first motion offset information.

6. The method according to claim 5, wherein the obtaining or determining the motion information of the sub-processing unit based on the first motion offset information comprises:
determining the collocated sub-processing unit based on position information of the sub-processing unit and the first motion offset information; and
obtaining or determining the motion information of the sub-processing unit based on the position information and/or the motion information of the collocated sub-processing unit.

7. The method according to claim 2, wherein the sixth method comprises:
determining the first motion offset information based on second motion offset information, and obtaining or determining the motion information of the sub-processing unit based on the first motion offset information.

8. The method according to claim 1, further comprising at least one of the following:
the first image unit is an image unit of the same size as the unit to be processed;
the first sub-image unit is a sub-image unit of the same size as the sub-processing unit;
the second motion offset information comprises: motion information of at least one first area and/or at least one first sample of the first image unit or the first sub-image unit; and
the preset flag comprises a first value and/or a second value.

9. A processing device, comprising: a memory and a processor, wherein the memory stores an image processing program, and when the processor executes the image processing program, the image processing program implements the image processing method according to claim 1.

10. A non-transitory computer-readable storage medium, wherein the non-transitory computer-readable storage medium stores a computer program, and when the computer program is executed by a processor, the image processing method according to claim 1 is implemented.
